(19) United States
(12) Patent Application Publication
(10) Pub. No.: US 2004/0215769 A1
(43) Pub. Date: Oct. 28, 2004

(54) Communication device and program and recording medium for the communication device

(76) Inventors: Shikio Yoshida, Nara-shi (JP); Toru Ueda, Kyoto (JP); Akiteru Deguchi, Yamatokoriyama-shi (JP)

Correspondence Address: BIRCH STEWART KOLASCH & BIRCH, PO BOX 747, FALLS CHURCH, VA, 22040-0747, US

(21) Appl. No.: 10/829,280

(22) Filed: Apr. 22, 2004

(30) Foreign Application Priority Data
Apr. 24, 2003 (JP) 2003-119450

(51) Int. Cl. G06F 15/173; H04J 3/00

(52) U.S. Cl. 709/224; 709/238

(57) ABSTRACT

In a display device, when an application operating section is to communicate, each communication state detecting section detects a communication state of each radio communication section. A physical layer selecting section then determines if each physical layer is capable of providing an effective throughput required by each application operating section by each radio communications section. Furthermore, the physical layer selecting section selects from the physical layers a physical layer available for communications of each application operating section.

This Nonprovisional application claims priority under 35 U.S.C. § 119(a) on Patent Application No. 2003-119450 filed in Japan on Apr. 24, 2003, the entire contents of which are hereby incorporated by reference.

### FIELD OF THE INVENTION

The present invention relates to a communication device, which permits communications using a plurality of physical layers, and also relates to a program, which realizes the communications using the plurality of physical layers, and a recording medium storing the program.

### BACKGROUND OF THE INVENTION

Conventionally, communication devices can be roughly classified into (1) transmission/receiving devices of wired lines for transmitting and receiving electric signals, optical signals, etc., using wired transmission media such as electric wires, optical fibers, etc., and (2) radio communication devices for transmitting and receiving electric signals (electric waves), infrared ray signals using free spaces as transmission media.

When comparing these communication devices, (1) the communication devices of wired line are advantageous in that the transmission rate and the effective throughput can be obtained as desired relatively with ease, but disadvantageous in that a cable is needed for connecting communication devices. On the other hand, (2) the radio communication devices are advantageous in that the cable is not needed, but disadvantageous in that it is difficult to obtain the desired transmission rate and the effective throughput. In response, communication devices provided with a physical layer for communicating with a physical line for radio communication and a physical layer for wired communication have been proposed.

Moreover, the radio communication devices are liable to be affected by distances and obstacles between/among communication devices, and interferences from other communication devices, and each radio communication system has good points and bad points in view of the communication range, the transmission rate, the effect of interferences, the operation time, the number of communication devices to be communicated with the radio communication devices (diffusion ratio), etc. Namely, there is no satisfactory radio communication system in all aspects. Therefore, in order to realize communications by the plurality of radio communication systems, communication devices provided with physical layers have been developed.

For example, Japanese Unexamined Patent Publication No.11-252006/1999 (Tokukaihei 11-252006, published on Sep. 17, 1999 (to be described later)) discloses a communication device, which permits communications in both the PHS (registered mark) system and the PDC (Personal Digital Cellular) system. In this communication device, when a battery voltage becomes lower than a predetermined value, the PDC system can be switched to the PHS system in which the driving in the waiting mode is permitted even at low battery voltage, and therefore the waiting time can be increased.

### SUMMARY OF THE INVENTION

The present invention preferably provides a communication device that permits each application layer to communicate using an optimal physical layer at current communication state irrespectively of changes in communication state of respective plurality of physical layers with time and changes in communication quality level with time of each physical layer.

In particular, the communication device in accordance with a preferred embodiment includes:

a plurality of physical layers;

memory means for storing a communication quality level required by an application; and

physical layer selecting means for selecting among the plurality of physical layers, a physical layer currently capable of providing communications in the communication quality level required by the subject application, as a physical layer for the subject application to use in communicating. In the foregoing structure of the communication device, the communication quality level may be determined, for example, by an effective throughput, a response time, a transmission rate of the physical layer or a receiving radio field intensity.

According to the foregoing structure, the memory means stores the communication quality level required by the application; and the physical layer selecting means selects among the plurality of physical layers, a physical layer currently capable of providing communications in the communication quality level required by the subject application. According to the foregoing structure, even when a communication state of each physical layer changes with time, and the communication quality level of each physical layer changes with time accordingly, it is still possible to select an optimal physical layer that permits each application to communication in the current communications state.

The foregoing communication device may be realized by hardware, or may be realized by making a computer execute the program. Specifically, the communication device may be realized by the program, which makes a computer operate as:

memory means for storing a communication quality level required by an application; and

physical layer selecting means for selecting among the plurality of physical layers, a physical layer currently capable of providing communications in the communication quality level required by the subject application, as a physical layer for the subject application to use in communicating. The recording medium in accordance with the present invention stores the foregoing program.

Upon executing the program by the computer, the computer operates as the communication device. Therefore, together with the communication device, the communication state by each physical layer changes with time, and accordingly, even when the communication quality level offered by each physical layer changes with time, it is possible for each application to communicate by using the physical layer optimal for the current communication state.

It is preferable that the communication device having the foregoing structure be arranged such that:

in the case where none of the physical layers is capable of providing communications in the quality level required by the subject application, the physical layer selecting means informs that to the subject application to urge it to lower the communication quality level to be required.

According to the foregoing structure, in the case where none of the physical layers is capable of providing communications in the quality level required by the subject application, the physical layer selecting means informs that to the subject application to urge it to lower the communication quality level to be required. According to the foregoing structure, in the case where a sufficient communication quality for the transmission of a quality video signal cannot be ensured, the subject application can reduce the communication quality level to be requested to the physical layer selecting means, a level by a level, according to the current communication state.

The communication device having the foregoing structure may be further arranged such that:

the physical layer selecting means determines a current communication state of each of the plurality of physical layers according to a predetermined priority order set beforehand from that of the highest priority if it is capable of providing communications in the communication quality level required by the subject application, and selects the physical layer capable of providing communications in the communication quality level if any.

According to the foregoing structure, the physical layer of the lowest priority is selected only when all the other physical layers of the higher priority are not capable of providing the communication quality level as requested. It is therefore possible to omit the unnecessary process of confirming the communication quality unlike the structure of determining each physical layer if it is capable of providing communications in the communication quality level as requested. As a result, interference to other communications due to the detection of the communication state can be prevented.

The communication device of the present invention may be arranged such that the plurality of physical layers include the physical layer which communicates via the radio communication path.

It is preferable that the communication device having the foregoing structure be arranged such that the plurality of physical layers include a physical layer which communicates via the radio communication path, using a radio frequency band of either 2.4 [GHz] band or 5 [GHz] band.

It is preferable that the communication device having the foregoing structure may be further arranged such that at least one of the plurality of physical layers that communicates via the radio communication path is provided with a plurality of antennas, and when determining a current communication state of each of the plurality of physical layers if it is capable of providing communications in the communication quality level as required by the subject application, the physical layer selecting means switches an antenna among the plurality of antennas to obtain respective receiving states, and determines the current communication state of each of the plurality of physical layers based on a receiving state.

According to the foregoing structure, even when a communication state of each physical layer changes with time, and the communication quality level of each physical layer changes with time accordingly, it is still possible to select an optimal physical layer that permits each application to communication in the current communications state. As a result, irrespectively of the plurality of physical layers include the physical layer which communicates via the radio communication path, whose communication state is liable to change, each application can communicate using the physical layer optimal for the current communication state.

The communication device having the foregoing structure may be further arranged such that the physical layer that communicates via the radio communication path is provided in plural number, and a physical layer having a highest radio frequency of the plurality of physical layers is provided with a mobile antenna that permits its installation position to be changed. Incidentally, not only the physical layer of the highest radio frequency band but also other physical layers may be provided with the mobile antenna.

According to the foregoing structure, the communications are performed using the physical layer of the highest radio frequency band, by high frequency and very linear electric wave, and in response, the physical layer whose communication state is most liable to change by the placement position of the antenna is provided with a mobile antenna. As a result, it is possible to improve the communication state by adjusting the placement position of the antenna.

The communication device having the foregoing structure may be arranged such that:

at least one of the plurality of physical layers that communicates via the radio communication path includes a mobile antenna that permits its installation position to be changed, and

the communication device further comprising:

stoppage instruction means for temporally stopping the operation of selecting the physical layer by the physical layer selecting means while the placement position of the mobile antenna is being adjusted.

According to the foregoing structure; however, the automatic selection of the physical layer by the physical layer selecting means is stopped while the placement position of the mobile antenna is being adjusted. It is therefore possible to prevent a wrong selection of the optimal physical layer. As a result, the physical layer selection means can more appropriately select the optimal physical layer.

It is preferable that the communication device having the foregoing structure be arraigned such that:

the plurality of physical layers include plural physical layers that communicate via the radio communication path, and

the priority order of these physical layers is set such that the higher is the radio field frequency, the higher is the priority order.

According to the foregoing structure, the higher is the physical layer, i.e., the longer is the communication distance, the worse is the communication state; on the other hand, the physical layer that is less likely to have an interference from other apparatus and is capable of providing quality communication is preferentially selected. Therefore, in the area wherein communication can be performed at a short distance, using a high frequency physical layer, it is possible to stabilize the communication quality by communicating by the physical layer. On the other hand, in the area wherein the communication distance is long, and physical layer of high frequency cannot be used, a physical layer of lower frequency, which permits the longer distance communications is selected. As a result, as compared to the structure of adopting only the physical layer of low frequency, the communication quality level for the short distance communication can be more stabilized, and as compared to the structure of adopting only the high frequency physical layer, it is possible to increase the area in which the communications can be performed in the communication quality level requested by the application.

It is preferable that the communication device having the foregoing structure be arranged such that:

the memory means stores the priority order of the plurality of physical layers independently for each application, and

upon selecting a physical layer for the application to use in communicating, the physical layer selecting means reads out the priority order of the application from the memory means and selects the physical layer according to the priority order.

According to the foregoing structure, the priority order can be set for each application. It is therefore possible to select the physical layer most suited for the application in the current communication state.

The communication device having the foregoing structure may be arranged such that:

the physical layer selecting means selects a physical layer for the subject application to use in both directions of transmitting and receiving.

According to the foregoing structure, the same physical layer is adopted in both directions of transmitting and receiving, and thus the communication by the subject application is less likely to interfere the communications by other applications.

The communication device having the foregoing structure may be arranged such that:

the physical layer selects the first physical layer for use in transmitting a signal in a transmitting direction or a receiving direction which is mainly used, at least one of the plurality of physical layers that communicate via the radio communication path are provided with a plurality of antennas, and selects from other physical layers than the second physical layer for use in signal transmission in other direction. According to the foregoing structure, the physical layer for use in transmitting is different from the physical layer for use in receiving. It is therefore possible to offer a wider band for the application.

It is preferable that the communication device having the foregoing structure be arranged such that:

the memory means stores a transmission method of either full-duplex transmission or half-duplex transmission to be adopted for each application; and

in the case where the stored transmission method for the subject application is a half duplex transmission, the physical layer selecting means selects a physical layer for both transmitting and receiving directions to be used for the application; while, in the case where the transmission method stored for the subject application is a half duplex transmission, the physical layer selecting means selects a physical layer for use in transmitting a signal in either a transmitting direction or a receiving direction which is mainly used, and selects from other physical layer than the physical layer for use in transmitting a signal in the mainly used direction, for use in transmitting a signal in the other direction.

According to the foregoing structure, whether the half-duplex transmission or the full-duplex transmission is to be adopted may be set for each application. As a result, it is possible to select the physical layer most suited for the application.

The communication device having the foregoing structure may be arranged such that:

the physical layer selecting means is provided with physical layer fixing means which makes the physical layer selecting means select a predetermined physical layer for the subjection application to use in communicating, irrespectively of a communication state.

According to the foregoing structure, the physical layer fixing means makes the physical layer selection means select the predetermined physical layer according to the kind of the application or an instruction given by the user. As a result, the interference to the radio frequency band to be used for the communications, which require other QoS guarantee can be prevented.

It is preferable that the communication device having the foregoing structure be arranged such that:

the physical layer fixing means makes the physical layer selecting means select the predetermined physical layer only when the subject application does not require the band guarantee.

According to the foregoing structure, the physical layer fixing means makes the physical layer selection means select the predetermined physical layer only when the subject application does not require the band guarantee. As a result, the interference to the radio frequency band to be used for other communications, which require QoS guarantee can be prevented.

The communication device having the foregoing structure is arranged such that:

in the case where the subject application starts communicating with a second correspondent different from a first correspondent which is a current correspondent of the subject application, the physical layer selecting means selects from the plurality of physical layers, a physical layer not in use by the subject application, as a physical layer for use in communicating with the second correspondent.

According to the foregoing structure, for the communications with the second correspondent, the physical layer not used for the communications with the second correspondent is selected. As a result, it is possible to communicate with the second correspondent without disturbing the communications with the first correspondent.

The communication device having the foregoing structure may be arranged such that:

in the case where the physical layer as selected for use in communicating with the second correspondent cannot be used, the physical layer selecting means selects the physical layer in use for communicating with the first correspondent to be used in common between the first correspondent and the second correspondent.

According to the foregoing structure, in the case where the physical layer as selected for use in communicating with the second correspondent cannot be used, the physical layer selecting means selects the physical layer in use for communicating with the first correspondent to be used in common between the first correspondent and the second correspondent. As a result, it is possible to more surely communicate with the second correspondent. Incidentally, in the case where there exists an available physical layer, that available physical layer is adopted, and therefore it is less likely to interfere the communications with the first correspondent.

The communication device having the foregoing structure may be arranged such that:

in the case where the subject application starts communicating with a second correspondent different from a first correspondent to which the subject application is communicating, the physical layer selecting means selects between the first physical layer in use by the subject application and the second physical layer, the second physical layer to be used in common between the first correspondent and the second correspondent.

According to the foregoing structure, when communicating with the second correspondent, the second physical layer is used in common. As a result, it is possible to communicate with the second correspondent without disturbing communications in the direction of transmitting or receiving which is mainly used (the communication direction by the first physical layer).

The communication device having the foregoing structure may be further arranged such that:

in the case where the physical layer as selected for use in communicating with the second correspondent cannot be used, the physical layer selecting means selects the first physical layer to be used in common between the first correspondent and the second correspondent.

According to the structure, in the case where the physical layer adopted for the communications with the second correspondent cannot be used, the first physical layer is used in common. As a result, it is possible to more surely communicate with the second correspondent. Incidentally, in the case where there exists an available physical layer, that physical layer is adopted, and therefore it is less likely to interfere the communications with the first correspondent.

The communication device having the foregoing structure may be further arranged so as to include: communication state presenting means which presents a communication state of each of the plurality of layers, for example, by outputting a voice sound, or displaying the communication state. According to this structure wherein the communications state of each physical layer is presented, it is possible to urge the subject application to improve the communication state, for example, by adjusting the variable factors in the communication device if the current communication state is not desirable. Incidentally, in the case where the physical layer communicates via the radio communication path, by moving the communications device or adjusting the antenna, it is possible to improve the communication state with ease as compared to the case of adopting the wired line. As described, the foregoing structure of presenting the communication state of each physical layer can be fully appreciated.

The communication device having the foregoing structure may be further arranged such that in the case of adopting a plurality of applications, the communication state presenting means presents if a communication state of each physical layer is capable of providing communications in the communication quality level required by each application.

According to the foregoing structure wherein the communication state presenting means presents if a communication state of each physical layer is capable of providing communications in the communication quality level required by each application, the user can see if each physical layer is capable of providing communications as requested by each application without recognizing the communication quality level requested by each application, and thus can take an appropriate action.

The communication device having the foregoing arrangement may be arranged such that the communication state presenting means presents not only the communication state of each of the plurality of physical layers but also the physical layer being selected by the physical layer selecting means. According to the foregoing structure, since the physical layer currently being selected is presented for the user, the user can surely recognize the communication state of the physical layer in use.

The communication device having the foregoing structure may be arranged such that:

the communication state presenting means presents the communication state together with a display by the application. According to the foregoing structure, the communication state is displayed together with the display by the application. As a result, the user needs not check the communication state by switching the display by the application, and can recognize the communication state with a simpler manner.

The communication device of the present invention may be a video receiving device or a video storage device. The communication device of the present invention may be a video transmitting device. As the foregoing communication devices required communications with band guarantee in transmitting or receiving a video signal, the effect of providing the physical layer selecting means can be fully appreciated.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating essential structures of display device in accordance with one embodiment of the present invention.

FIG. 2 is a block diagram illustrating a communication system including the display device.

FIG. 3 is a drawing illustrating one example showing a communication state shown in the display device.

FIG. 4 is a block diagram illustrating an example of a hardware structure showing essential parts of the display device.

FIG. 5 is a block diagram showing essential structures of another communication device contained in the communication system.

FIG. 6 is a flowchart showing operations of the display device.

FIG. 7 is a drawing showing operations of the communication system wherein a display device and a signal source perform a full-duplex transmission.

FIG. 8 is a drawing showing operations of the communication system wherein a display device and a signal source perform a full-duplex transmission.

FIG. 9 is a flowchart showing operations of the display device in the case of communicating with other communication party than a current communication party.

FIG. 10 is a drawing showing the state wherein the display device starts communicating with an access point in the half duplex transmission with the signal source, wherein an available physical layer can be used.

FIG. 11 is a drawing showing the state wherein the display device starts communicating with an access point in the half duplex transmission with the signal source, wherein an available physical layer cannot be used.

FIG. 12 is a drawing showing the state wherein the display device starts communicating with an access point in the full duplex transmission with the signal source, wherein a physical layer for control signal transmission can be used.

FIG. 13 is a drawing showing the state wherein the display device starts communicating with an access point in the full duplex transmission with the signal source, wherein a physical layer for control signal transmission cannot be used.

FIG. 14 is a block diagram showing essential structures of a display device in accordance with another embodiment of the present invention.

FIG. 15 is a block diagram showing a modified example of each display device.

FIG. 16 is a block diagram showing a structure of a hardware showing essential parts of the display device in accordance with the modified example.

### DESCRIPTION OF THE EMBODIMENTS

### First Embodiment

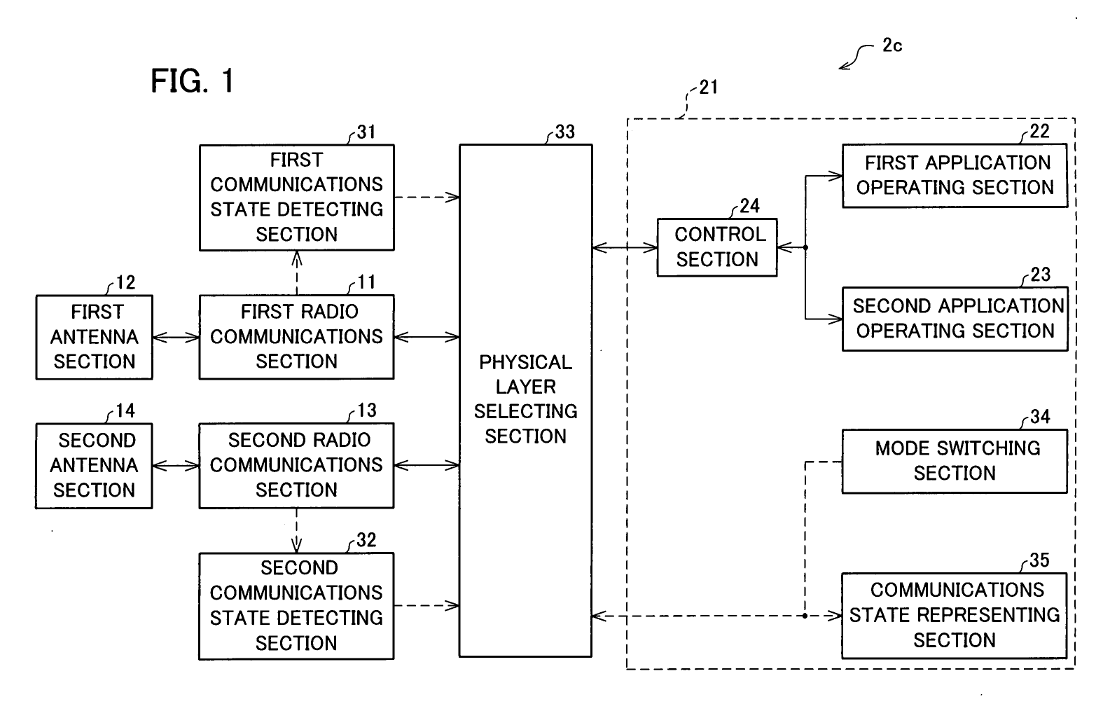

The following descriptions will explain one embodiment of the present invention in reference to FIG. 1 through FIG. 13. The communication system in accordance with the present embodiment is made up of a plurality of communication devices, which can communicate each other using physical layers of plural types, wherein even in the case where a communication state in each physical layer changes with time, and the communication quality level of each physical layer changes with time, each application layer can communicate using an optimal physical layer in the current communication state.

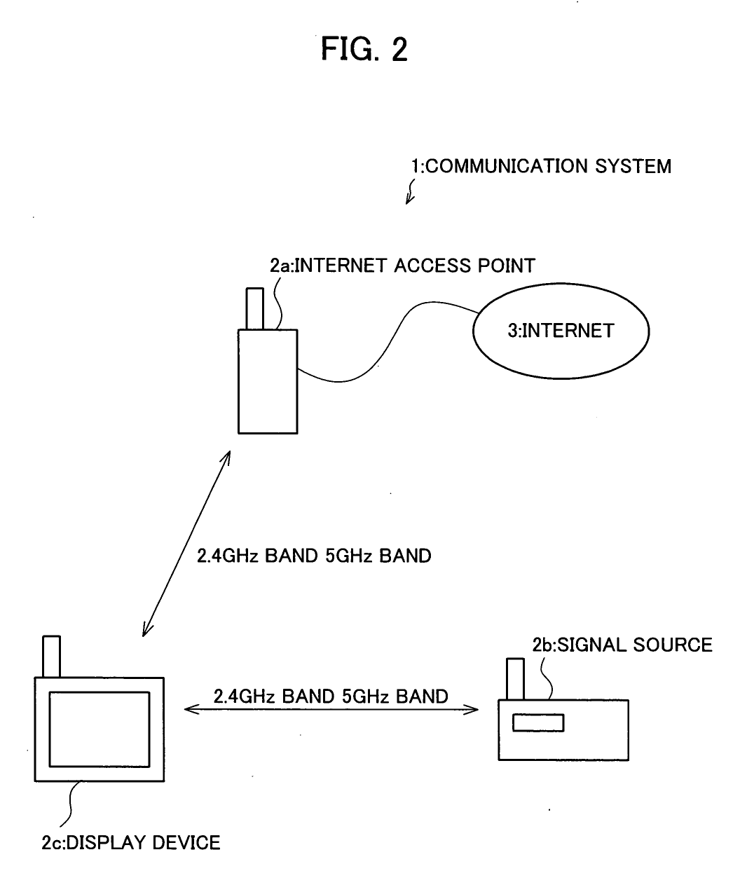

As to the functions of the communication devices and physical layers of each communication device for the foregoing communication system, a variety of applications may be adopted. FIG. 2 shows an example of the communication system 1, which includes as a communication device 2 made up of an access point 2a to be communicated with an internet 3, a signal source 2b capable of transmitting an AV (Audio Visual) signal and a control signal such as a hard disk recorder, and a display device 2c connected to an internet 3 via the access point 2a in response to an instruction from the user to browse various pages available to the public on the internet 3 and reproduce an AV signal from the signal source 2b, wherein the foregoing members can communicate with each other via radio transmission paths of various kinds.

In the communication system 1 of the present invention, the number of communication device for switching a physical layer is not particularly limited. In the following, however, explanations will be given through the case where only the display device 3c switches the physical layer.

As illustrated in FIG. 1, the display device 2c of the present embodiment includes as physical layers of various types, a first radio communication section 11, a first antenna section 12, a second radio communication section 13 and a second antenna section 14.

In the present embodiment, the first wiring section 11 and the first antenna section 12 which serve as the first physical layer is capable of performing radio communication at a frequency of 5 [GHz] according to IEEE802.11a. On the other hand, the second radio communication section 13 and the second antenna section 14 are physical layers of various kinds different from the first physical layer (for example, the physical layer different from the first physical layer in communications system, radio communication frequency or communication media), and is capable of performing a radio communication at a frequency of 2.4 [GHz] according to IEEE 802.11g.

The display device 2c includes a data processing section 21, which operates as the upper layer than the physical layer. The display device 2c in accordance with the present embodiment has a function of reproducing the AV signal from the signal source 2c and the function of browsing a page on the internet 3. Therefore, in the data processing section 21, as application layers to be realized respectively, provided in the data processing section 21 are a first application operating section 22 and a second application operating section 23 and a control section 24 to be operated as a layer between the application layer and the physical layer.

The display device 2c in accordance with the present invention includes a physical layer selecting section (physical layer selecting means, memory means) 33 capable of selecting physical layers for the first and second application operating sections 22 and 23 based on results of detections of the communication states of the first and second radio communication sections 11 and 13 by a first communications state detecting sections 31 and a second communications state detecting section 32.

Here, when each of the first and second application operating sections 22 and 23 communicates, the qualities of respective communications required for the communication path differ (in effective throughput, response time, etc.). However, the physical layer selecting section 33 determines a communication quality level when adopting each of the plurality of physical layers based on the results of detections by each of the first communications state detecting sections 31 and the second communications state detecting section 32, and selects a physical layer which permits the communication in the quality level required by each of the first and second application operating sections 22 and 23.

In the case where the plurality of physical layers are capable of providing communications quality level required by each of the first and second application operating sections 22 and 23, the physical layer selecting section 33 in accordance with the present embodiment selects a physical layer for use in communications of each of the first and second application operating sections 22 and 23 according to the predetermined priority order. As in the case of the communication quality level, this priority order can be set for each of the first and second application operating sections 22 and 23 by each of the first and second application operating sections 22 and 23 itself and other application operating section (mode switching section 34, to be described later). These members 22, 23 and 25 correspond to the physical layer fixing means recited in claims.

Furthermore, when each of the application operating sections 22 and 23 communicates, the physical layer selecting section 33 in accordance with the present embodiment can set either to use the same physical layer in common, for example, by the time division (half duplex transmission) or to use different physical layer for each transmission/receiving (full duplex transmission).

In the present embodiment, the communication quality, priority order, modes to be described later and half duplex transmission/full duplex transmission can be set for each of the application operating sections 22 and 23 by each of the application operating sections 22 and 23 and the application operating section.

According to the foregoing structures, even in the case where the communication state of each of the radio communication sections 11 and 13 changes with time, and the communication quality level offered by each of radio communication sections 11 and 13 changes with time accordingly, communications can be performed in an optimal manner for the current communication state.

In the following, the respective structures of the first communications state detecting sections 31, the second communications state detecting section 32 and the physical layer selecting section 33 will be explained through the case wherein each of the application operating sections 22 and 23 requires for an effective throughput of not less than a predetermined level as a communication quality level.

Namely, the effective throughput and the transmission rate (physical rate) of the physical layer are mutually correlated, and in order to provide a certain effective throughput, it is required to set a physical rate be not less than the rate corresponding to that effective throughput. Similarly, the physical rate and the electric wave receiving state (receiving radio field intensity, for example) are mutually correlated, and in order to provide a certain physical rate, and it is required to set the electric wave receiving state be not less than the level corresponding to that physical rate.

The physical layer selecting section 33 determines if each of the first and second application operating sections 22 and 23 can provide an effective throughput as required by each of the application operating sections 22 and 23 by determining if each electric wave receiving state is higher than the level corresponding to the effective throughput based on the above correlations, and each of the first communications state detecting sections 31 and the second communications state detecting section 32 detects the electric wave receiving state as a result of detection of the communication state.

The first application operating section 22 in accordance with the present embodiment is capable of reproducing an AV signal from the signal source 2b, and is realized by the application that requires a band guarantee. To realize quality video transmission, for example, the first application processing section 22 requires for an effective throughput 24 [Mbps], and the physical layer selecting section 33 determines based on the effective throughput, the physical rate of 36 [Mbps] is needed, and then determines if each of the radio communication sections 11 and 13 can provide the effective throughput required by the first application operating section 22, depending on whether or not the electric wave receiving state as detected by each of the first communications state detecting sections 31 and the second communications state detecting section 32 is higher than the level required for the physical rate (the level of the electric wave receiving state adopting the sub carrier modulation system which permits the above physical rate to be realized).

The physical layer selecting section 33 in accordance with the present embodiment has a mode (automatic selection mode) of automatically selecting a physical layer that can provide the communication quality level as required by each of the application operating sections 22 and 23 among the plurality of physical layers, and a mode (fixed mode) of selecting a predetermined physical layer corresponding to each of the application operating sections 22 and 23 irrespectively of the communication state. With this structure, when each of application operating sections 22 and 23 selects the fixed mode and gives an instruction to select the specific physical layer, the physical layer selecting section 33 selects the physical layer irrespectively of the communication state.

The data processing section 21 in accordance with the present embodiment is provided with the switching mode switch section 34 in replace of the application operating sections 22 and 23, for setting the mode in the physical layer selecting section 33 when each of the application operating sections 22 and 23 communicates. With this structure, the user of the display section 2c switches the mode of each of the application operating sections 22 and 23 by giving an instruction to the mode switching section 34.

Furthermore, the data processing section 21 in accordance with the present embodiment is provided with the communication state presenting section (communication state presenting means) 35, which displays the communication state of each physical layer. With this structure, it is possible to provide the user of the display device 2c, with the communication state in physical transmission.

As described, the display device 2c in accordance with the present embodiment is provided with the communication state presenting section 35, which displays the communication state of each physical layer. With this structure, the user of the display device 2c can recognize the current communication state of each physical layer. It is therefore possible for the user to adjust the relative position of each communication device 2 in the communication system 1 or to take out the apparatus device, which may cause an interference with the communication by each physical layer (the communication device that communicates in other communication standard, the apparatus which may cause noise, etc., to be described later). As a result, the communication state of each physical layer can be improved.

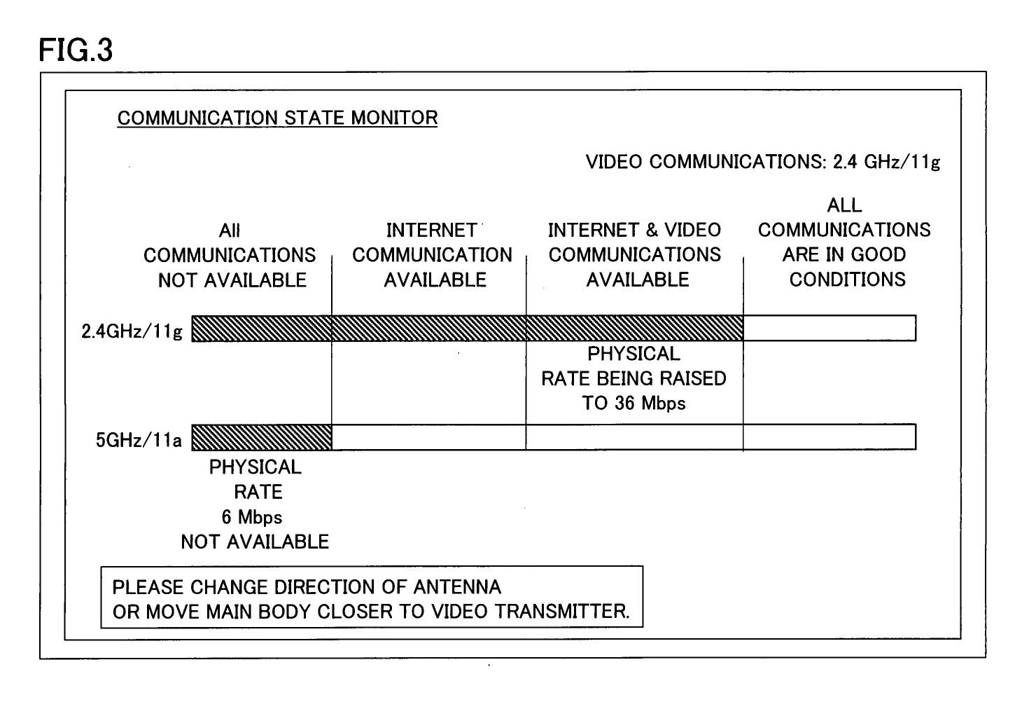

As illustrated in FIG. 3, the communication state presenting section 35 in accordance with the present embodiment informs the user of the display device 2c if each communication state is of sufficient quality level for each of the application operating sections 22, 23.

In the example of FIG. 3, the communication state presenting section 35 displays the physical rate of each physical layer by a bar graph, and each bar graph is graduated at a position (physical rate) corresponding to the effective throughput required by each of the application operating sections 22 and 23. Further, an each interval between adjacent graduations, functions of the available application operating sections a when the physical rate falls in the interval are displayed.

For example, FIG. 3 shows the case where each of the application operating sections 22 and 23 has a video communication function and an internet communication function, and the communication state representing section 35 displays the communication state by four levels (1) communication unavailable; (2) internet communication unavailable; (3) internet & AV communication unavailable; and (4) internet communication & AV communication available in good conditions.

FIG. 3 shows the structure wherein the display device 2c and other communication device 2 are provided at relatively short distance. In this state, the physical rate of the second radio communication section 13 which communicates at 2.4 [GHz] is 36 [Mbps]. The graph which shows the physical rate indicates an interval in which the respective functions of both the first application operating section 22 and the second application operating section 23 are available.

On the other hand, in the above state, the physical rate of the first radio communication section 11 which communicates at 5 [GHz] is lower than 6 [Mbps], and the graph indicative of the physical rate indicates an interval in which none of the functions of the first and second application operating sections 22 and 23 are unavailable. It is therefore possible for the user of the display section 2c that the communication state of the first radio communication section 11 is insufficient for both of the first and second application operating sections 22 and 23.

As described, the communication state presenting section 35 in accordance with the present invention indicates that the current communication state of each physical layer is good enough to use for which of the application operating sections 22 and 23. With this structure, it is therefore possible for the user of the display device 2c to recognize with ease for which of the application operating sections 22 and 23, the current communication state of each physical layer is good enough unlike the case in which only the physical rate of each physical layer is displayed, it is required for the user of the display device 2c to obtain the necessary physical rate for the use of each application operating section to determine for which of the application operating sections 22 and 23, the current communication state is good enough. As described, when an attempt is made to improve the communication state of each physical layer, by referring to the display of the communication state presenting section 35, it is possible to recognize such attempt is sufficient for the use of the physical layer as desired for the communication of the predetermined application operating section.

As illustrated in FIG. 3, the communication state presenting section 35 in accordance with the present embodiment indicates the physical rate that each physical layer can currently transmit, or the OFDM sub carrier modulation system. It is therefore possible for the user of the display device 2c to recognize detailed communication state from the above information indicated by the communication state presenting section 35.

Furthermore, the communication state indicating section 35 in accordance with the present invention can provide remedial measures when it is determined that the communication state in certain physical layer is not good enough for the use of the physical layer. In the example shown in FIG. 3, the communication state presenting section 35 in accordance with the present embodiment displays a message “change a direction of an antenna” as a remedial measure that can be adopted in common for all the application operating sections. In this example of FIG. 3, the communication state indicating section 35 determines that the communication state is not good enough for the use of the first application operating section 22, and therefore displays a message “move the main body closer to the transmitter of the video” as remedial measures corresponding to the first application operating section 22 among the remedial measures prepared for the application operating sections 22 and 23 respectively. It is therefore possible for the user of the display section 2c to provide the remedial measures for the current communication state with ease.

As illustrated in FIG. 3, the communication state display section 35 in accordance with the present embodiment displays the physical layer each operating section 22, 23 is being used in addition to the communication state. As a result, it is possible for the user to recognize the communication state of the physical layer being used.

The communication state presenting section 35 in accordance with the present invention displays the communication state together with the display of each of the application operating sections 22 and 23 in an area above the display area used by each of the application operating sections 22 and 23. With this structure, it is not required for the user to switch the screen from the display screen of each of the application operating sections 22 and 23 to see the communication state. As a result, the user can quickly recognize the communication state.

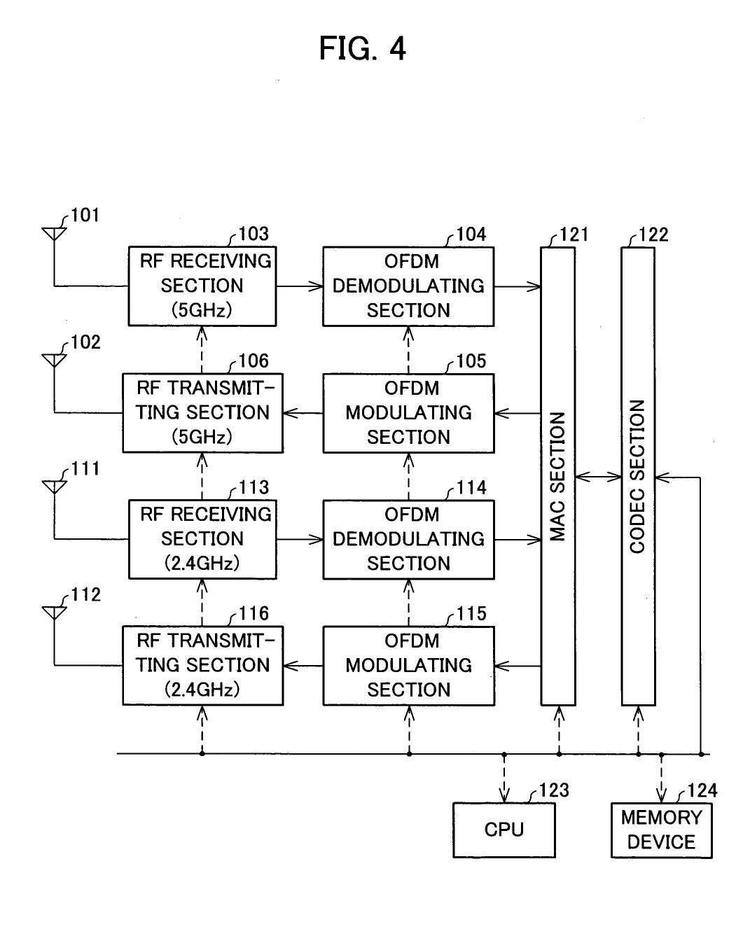

In the following, an example of the hardware structure of the display device 2c will be briefly explained. Namely, as illustrated in FIG. 4, the display device 2c includes antenna sections 101, 102, 111 and 112 which permit efficient transmission and receiving at two radio transmission frequency bands 2.4 [GHz] and 5 [GHz] as the first antenna section 12 and the second antenna section 14.

Furthermore, the display section 2c includes as the first radio communication section 11, an RF receiving section 103, an OFDM demodulation section 104, an OFDM modulation section 105, and an RF transmitting section 106. The RF receiving section 103 is provided for down converting a signal in a radio transmission frequency band (5[HGz]) as received by the antenna section 101 and outputting a base band signal. The OFDM demodulation section 104 is provided for generating a digital data string by base band demodulating the base band signal from the RF receiving section 103 to generate the digital data string to be output to the control section. The OFDM demodulation section 105 is provided for base band modulating and demodulating the digital data string from the control section. The RF transmitting section 106 is provided for generating a signal in a radio transmission frequency band by up-converting the base band signal modulated by the OFDM modulation section 105 to be transmitted from the antenna section 102. Similarly, the display section 2c includes as the second radio communication section 13, the RF receiving section 113 for 5 [GHz], the OFDM modulation section 114, the OFDM modulation section 115 and the RF transmitting section 116.

The display device 2c includes the modulation or demodulation sections 104, 105, 114 and 115, which are connected in common. The display section 2c also includes a MAC section (media access control block) 121, a CODEC (coder and decoder) section 122, a CPU 123, and a memory section 124 to be accessed by the CPU 123. The MAC section 121 is provided for storing various digital data strings (digital video data string, voice data string, information data strings, etc.) to be transmitted between communication devices 2 in a format suited for transmission, for example, by dividing the digital data strings into packets suited for transmission and reading the data strings as stored. The CODEC section 122 is provided for encoding/decoding. The CPU 123 is provided for controlling each of the members 101 to 122 according to the need. The respective members 22 to 24, and 33 to 36 (some of them are to be described later) are functional blocks to be realized by executing the program stored in the memory 124 to control respective members 101 to 136 (to be described later) or the peripheral circuit such as input/output circuit (not shown) by the CPU 123. The communication device 2 in accordance with the present embodiment is the display device 2c. Therefore, the peripheral circuits of the communication device 2 include devices which realize the interface function with user and other apparatuses, such as connection terminals to be connected to a keyboard, a camera, a video apparatus, and a video display device, etc. Each of the receiving sections 103 and 113 functions also as the first communications state detecting sections 31 and the second communications state detecting section 32, and outputs the receiving electric field intensity (RSSI: Received Signal Strength Indicator, etc.) indicative of the electric wave receiving state to the members (such as CPU 123, etc.,) which realize the physical layer selecting section 33. In FIG. 4, an arrow in dotted line indicates the transmission of a control signal, a receiving electric wave intensity, etc., different from the data string to be transmitted/received.

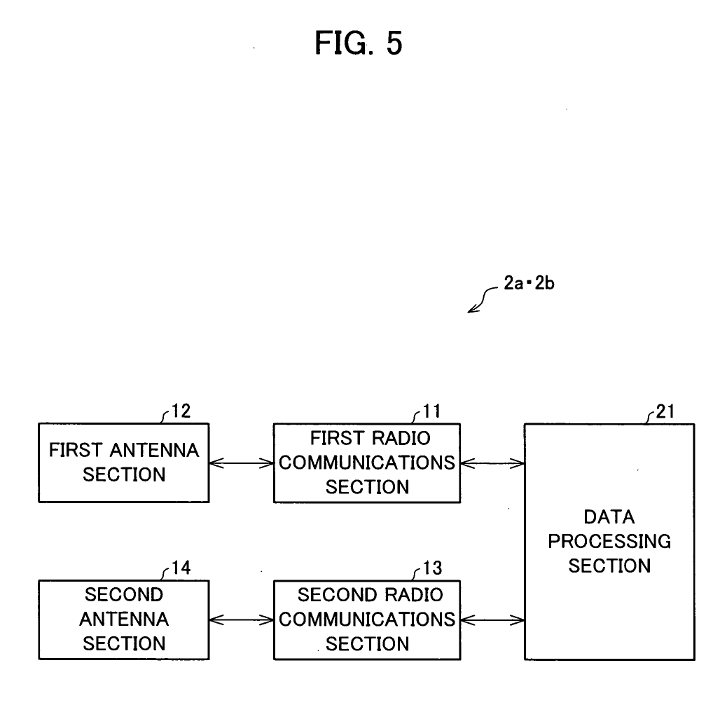

On the other hand, as illustrated in FIG. 5, other communication device 2 (an access point 2a, a signal source 2b) is provided with the first radio communication section 11 to the second antenna section 14, and a data processing section 21. However, in the present embodiment, these communication devices 2a and 2b perform communications in the same physical layer as the physical layer the display device 2c uses without instructing the other communication device 2 to switch the physical layer, the first communications state detecting section 31 to the communications state presenting section 35 are omitted. Incidentally, each of the communication devices 2a and 2b have different functions from the display device 2c, the data processing section 21 according to respective functions is provided. For ease in explanations, when it is necessary to specify which of the members of the communication device 2, the same alphabet as the alphabet assigned to the communication device 2 is added to refer to, such as a data processing section 21a for the access point 2a. On the other hand, when it is not necessary to specify which of the members, or described in the generic term, the alphabet at the end shall be omitted such as the data processing section 21.

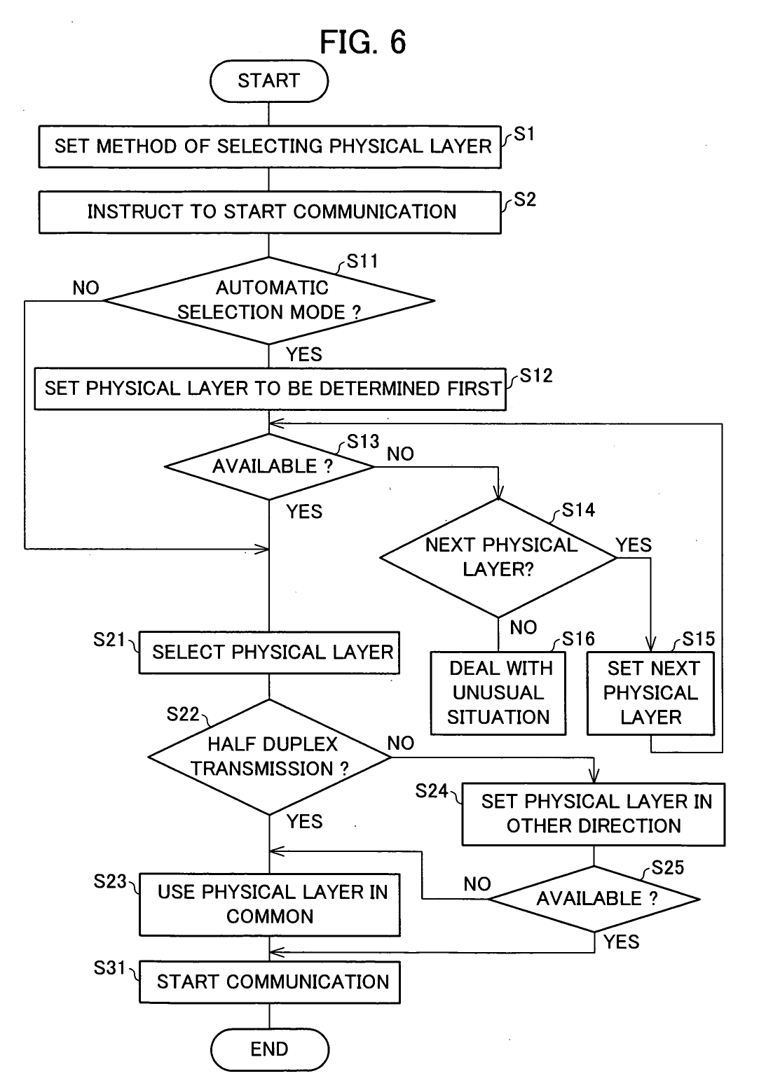

The operation of the physical layer selecting section 33 for selecting the physical layer to be used for the communication with the first application operating section 22 with the foregoing structure will be explained in reference to FIG. 6.

In the application operating sections 22 and 23 in accordance with the present embodiment, in step 1 (hereinafter referred to as S1), respectively instruct the physical layer selecting section 33 which of the modes is to be selected among the fixing mode/automatic selection modes. In the case where the fixing mode is to be specified, each of the application operating sections 22, and 23 instructs the physical layer selecting section 33 the physical layer to be selected. On the other hand, in the case where the automatic selection mode is to be specified, each of the application operating sections 22 and 23 instructs the physical layer selecting section 33 the effective throughput required for the communications. In the present embodiment, it is also possible to set the priority order in the case where the plurality of physical layers are capable of providing the effective throughput as required, and each of the application operating sections 22 and 23 therefore sets the priority order when instructing the automatic selection mode to the physical layer selecting section 33. Furthermore, according to the present embodiment, it is possible to set either the half duplex transmission or the full duplex transmission to be adopted beforehand, and each of the first and second application operating sections 22 and 23 can set the half duplex transmission or the full duplex transmission in the physical layer selecting section 33.

After each of the application operating sections 22 and 23 sets the physical layer selecting method (the mode, the communication quality level, the priority order and the half duplex transmission/full duplex transmission) to the physical layer selecting section 33 beforehand, in response to the instruction to communicate from either of the application operating sections 22 and 23 (hereinafter referred to as the application operating section a) in S2, the physical layer selecting section 33 determines in S11 to S25 which physical layer is to be used for the communications of the application operating sections 22 and 23.

Specifically, the physical layer selecting section 33 confirms in S11 which mode is set by the application operating section a which instructs the communication in S2. In the case where the automatic selection mode is set, the application operating section a selects in S12 the physical layer of the highest priority as the physical layer which determines the communication state in S13 according to the priority order set in S1 and selects the physical layer of the highest priority as the physical layer for use in the determination in the communication state in S13.

Furthermore, the physical layer selecting section 33 determines in S13 if the communication state of the physical layer β as selected is capable of providing the effective throughput as required by the application operating section α based on the results of detection of the detecting section γ corresponding to the physical layer β as selected.

As described, in the present embodiment, the detecting section y detects the electric field intensity, and the physical layer selecting section 33 determines the level of the electric field intensity required for transmitting a signal at the physical rate, to realize the effective throughput. The physical layer selecting section 33 then determines if the application operating section α can use the physical layer β without problems, i.e., if the physical layer β is capable of providing the effective throughput by determining if the result of detection by the detecting section γ exceeds the above level.

When it is determined in S13 that the physical layer β is not capable of providing the effective throughput as required by the application operating section α, the physical layer selecting section 33 selects the physical layer of the second highest priority if any (YES in S14) as the physical layer β for detecting the communication of the physical layer next (S15), thereby repeating the processes in and after carrying out S13.

On the other hand, when it is determined in S13 that the physical layer β is capable of providing the effective throughput as required by the application operating section α, the physical layer selecting section 33 sets (selects) in S21 the physical layer β as the physical layer to be used for the communication of the application operating section α. In the case where the fixed mode is selected in S11, the physical layer selecting section 33 selects in S21 the physical layer β as set in S11.

In the present embodiment, when it is determined in S1 that none of the communication states of the physical layers as set as the physical layer of the application operating section α is capable of providing the effective throughput as required by the application operating section α (NO in S14), the physical layer selecting section 33 determines the current communications state to be an unusual situation, and informs the message “in the current communication state, none of the physical layers can provide the effective throughput as required by the application operating section α”. On the other hand, the application operating section a requests the physical layer selecting section 33 for a lower effective throughput than that currently required, or instructs the physical layer selecting section 33 to use another physical layer (S16) to deal with this unusual situation.

In the present embodiment, either the half duplex transmission or the full duplex transmission can be selected in S11, and the physical layer selecting section 33 allocates the physical layer as selected in S21 to the physical layer β1 either the transmitting direction or the receiving direction whichever has a higher priority, and in S22 to S25 below, the physical layer to be used as the physical layer β2 for other direction is selected.

Specifically, in the half duplex transmission (YES in S22), the physical layer selecting section 33 sets the physical layer β1 as selected in S21 as the physical layer β2 for another direction (S23). On the other hand, in the full duplex (NO in S22), the physical layer selecting section 33 sets a different physical layer β than the physical layer β1 as selected in S21 as the physical layer β2 for another direction (S24). The physical layer selecting section 33 further confirms if the physical layer β2 can be used, and when it is determined that the physical layer β2 cannot be used (if no in S24), the process in S23 is performed, and the physical layer β1 as selected in S21 is also used as the physical layer β2 for other direction by time division, and the application operating section a then performs the half duplex transmission. On the other hand, when it is confirmed that the physical layer β2 can be used, the application operating section a then performs the full duplex transmission using the physical layers β1 and β2.

Here, as in the case of selecting the physical layer β1, whether or not the physical layer β2 can be used may be determined depending on whether or not a predetermined communication quality level (effective throughput, etc.) is satisfied, or whether or not communications can be performed. Incidentally, according to the present embodiment wherein two physical layers are provided, the physical layer β2 is selected by simply selecting in S24 a different physical layer from the physical layer β1. However, in the structure wherein three or more physical layers are provided, it may be arranged so as to carry out the process similar to the process in S12 to S16, and among a plurality of physical layers different from the physical layer β1, the physical layer of the highest priority is selected among the plurality of physical layers other than the physical layer β1. Here, the process in S23 is performed in replace of the process of dealing with the unusual situation in S16.

In S21 to S25, upon selecting the physical layer β1 or the physical layer β2, the application operating section a communicates in S31 via the physical layer β.

As described, when the application operating sections 22 and 23 is to communicate, the physical layer selecting section 33 in accordance with the present embodiment selects the physical layer to be used for the communication, in the current communication state, the physical layer capable of providing the effective throughput as required by the application operating sections 22 and 23 in the current communication state. As a result, even when the communications state in each physical layer changes with time, and the communication quality level offered by each physical layer changes with time accordingly, each of the application operating sections 22 and 23 can communicate using an optimal physical layer in the current communication state.

Furthermore, the physical layer selecting section 33 in accordance with the present embodiment selects the optimal physical layer when a plurality of physical layers are capable of providing the effective throughput as required by each of the application operating sections 22 and 23. Therefore, when each of the application operating sections 22 and 23 is to communicate, by setting higher the priority of the physical layer, which can expect to maintain its communication quality level under stable conditions, it is possible to preferentially select such physical layer. As a result, it is possible to provide communication quality level as requested to each of the application operating sections 22 and 23 under stable conditions.

For example, the radio communication sections 11 and 13 are capable of communicating at radio frequency at 5 [GHz] band, and 2.4 [GHz] band respectively, and the maximum physical rate is 54 [MHz].

Different from the communication at 2.4 [GHz], the communication at 5 [GHz] has not much noise source (electric range, etc.) of the communication device in other communication regularity using the same frequency band (Bluetooth (registered mark), IEEE 802.11b, etc.), or in the same frequency band, and thus the problem of interference is less liable to occur. In the case of communicating at 2.4 [GHz] band, a signal is liable to run at the back of the shielding member, and besides, an amount of transmission loss is smaller as compared to the case of communicating at 5 [GHz] band, and thus the communications at 2.4 [GHz] is more suited for the long distance communications.

As a result, the communication at a frequency band of 5 [GHz] is liable to be affected by the positional relationship between the communication devices 2. Therefore, the communication state gradually changes relatively, and it is therefore easy for the user to expect or adjust the communication state. On the other hand, the communications at a frequency band of 2.4 [GHz] is less liable to be affected by the positional relationship between the communication devices 2; however, it is liable to be affected by other devices (communication device to be communicated in other communication standard, the noise source, etc.). The communication state therefore suddenly changes relatively, and it is therefore difficult for the user to predict or adjust the communication state.

Therefore, for example, like the first application operating section 22 which is capable of reproducing the AV signal from the signal source 2b, by setting the physical layer selecting section 33 such that the first application operating section 22 that requires the band guarantee preferentially selects the first radio communication section 11 which communicates at the band width of 5 [GHz], to the second radio communication section 13 which communicates at the band width of 2.4 [GHz], the first application operating section 22 can communicate at the frequency band of 5 [GHz] when the positional relationship between the communication devices 2 is capable of communicating at the band width of 5 [GHz] without having interferences from other communication device. In the case where the positional relationship between the communication devices 2 becomes outside the range in which the communication at the band width of 5 [GHz] is permitted, it is possible to communicate at the effective throughput as required by the first application operating section 22 by communicating at the band width of 2.4 [GHz]. According to the foregoing structure, it is therefore possible to increase the range of the communication area while maintaining the communication quality level (the effective throughput at substantially the same level can be maintained) as compared to the case of adopting the bandwidth 5 [GHz].

In the display device 2c in accordance with the present embodiment, as in the processes in and after S12, the communication state is detected in the priority order from the physical layer of the highest priority, and thus the communication states of only the physical layers that can be used are to be detected. As a result, unlike the structure wherein the respective communication states of all the physical layers including the physical later that is less likely to be used are detected, unnecessary detection of the communication state can be suppressed, and the interference to other communications due to the detection of the communication state can be prevented.

As in S16, in the display device 2c in accordance with the present embodiment, in the case where the communication state is poor, and there is no physical layer capable of providing the initially set physical layer, the physical layer selecting section 33 informs that to the application operating section a to urge it to show new communication quality level (effective throughput, etc.). Here, in the case where the application operating section a tries to transmit a quality signal such has an AV signal, etc., that requires the effective throughput of 20 [Mbps], for example), if the transmission of a signal of lower quality is permitted (AV signal that requires the effective throughput of 6 Mbs], the required signal quality level is lowered to permit the transmission of that signal. In this case, the physical layer selecting section 33 executes the process in and after S12, and selects the physical layer β capable of providing the communication quality level as corrected to be a lower quality level.

As an example, in the case where the effective throughput is corrected to be lower to 6 [Mbps], the physical layer selecting section 33 determines the level of the receiving radio field intensity required for communication at the physical rate (12 [Mbps]) capable of providing the effective throughput as a new threshold, and determines if each physical layer is capable of providing the effective throughput based on whether or not the communication quality level as detected by each of the first communications state detecting sections 31 and the second communications state detecting section 32 exceeds the level of the new threshold. As a result, the physical layer selecting section 33 selects a physical layer β capable of providing the effective throughput as requested. In the case where a plurality of physical layers β are capable of providing the effective throughputs as requested, the physical layer β of the highest priority will be selected.

As described, in the case where no physical layer can provide the initially set communication quality level, the physical layer selecting section 33 in accordance with the present embodiment informs that to the application operating section α to urge for an instruction of new communication quality. With this structure, the application operating section α capable of providing services by signal transmission in plurality of communication quality levels can provide communicate services in the communication quality level available in the current communication state. The application operating section α communicates using the physical layer β most suited for the current communication state for the transmission of signals in the communication quality.

In the following, the operations of the first application operating section 22 of receiving and reproducing the AV signal from the signal source 2b will be explained in details in reference to FIG. 4. In this example, in the physical layer selecting section 33, the automatic selection mode, the effective throughput 20 [Mbps] (physical rate 36 Mbps), and the half duplex transmission and 5 [GHz] are preferentially set for the first application operating section 22.

For example, when the signal source 2b is instructed for the transmission of the radio AV signal by switching ON the signal source 2b, the signal source 2b transmits the AV signal at the frequency band (5[GHz]) as previously set for the highest priority. The RF receiving section 103b therefore determines if any channel is available by determining the electric wave state of 5 [GHz]. When it is determined that there exists an available channel, the CPU 123b sets the OFDM modulation section 105b, the OFDM demodulation section 104b, and the RF transmission section 106b to be enable, thereby establishing a link to the display device 2c.

On the other hand, the display section 2c is set in the standby state, i.e., the wait state for the establishment of the linkage from other communication device 2, by switching ON the device switch. In this state, the CPU 123c as the physical layer selecting section 33 activates respective RF receiving sections 103c and 113c of the frequency bands 5 [GHz] and 2.4 [GHz] so as to monitor the radio wave state of the transmission path to wait for the link establishment from other communication device 2. In the wait state, in order to reduce the power consumption, other members 104c to 106c, and 114c to 116c in the radio communication sections 11 and 13 are set to be disable.

As described, in response to the request for an establishment of the link from the signal source 2b to the display device 2c by respective members 111b to 116b of the signal source 2b, in the display device 2c, the CPU 123c as the control section 24 activates the first application operating section 22 for displaying the radio AV signal as transmitted from the signal source 22, and the CPU 123c as the physical layer selecting section 33 performs the process in S11 to S25 shown in FIG. 6.

Specifically, in the display device 2c, respective RF receiving sections 103c and 113c as a first communications state detecting sections 31 and a second communications state detecting section 32 outputs the receiving radio field intensity as the receiving state, and the CPU 123c as the physical layer selecting section 33 compares the receiving radio field intensity as output from the receiving section 103 as the first communications state detecting section 31 corresponding to the first radio communication section 11 which is given a priority as the physical layer of the highest priority for the first application operating section 22 with the receiving radio field intensity level (reference level) corresponding to the predetermined effective throughput for the first application operating section 22 to determine if the receiving radio field intensity exceeds the reference level.

If it is determined that the receiving radio field intensity exceeds the reference level, the CPU 123c as the physical layer selecting section 33 determines that the communication state at the frequency band 5 [GHz] is more desirable than the reference level, and that the first radio communication section 11 is capable of providing the effective throughput as required by the first application operating section 22. In this example, the communication of the first application operating section 22 is set in the half duplex transmission, the CPU 123c can select the use of the first radio communication section 11 not only as the physical layer for receiving but also as the physical layer for transmitting, and the CPU 123c sets the OFDM modulation section 105c for the frequency band 5 [GHz] and the RF transmission section 106c to be enable.

Furthermore, the first radio communication section 11, the control section 24, and the members 101c to 106c as the first application operating section 22, the MAC section 121c, the CODEC section 124c and the CPU 123c establish a link with the signal source 2b via the radio transmission path of 5 [GHz] to establish the connection of the upper layer.

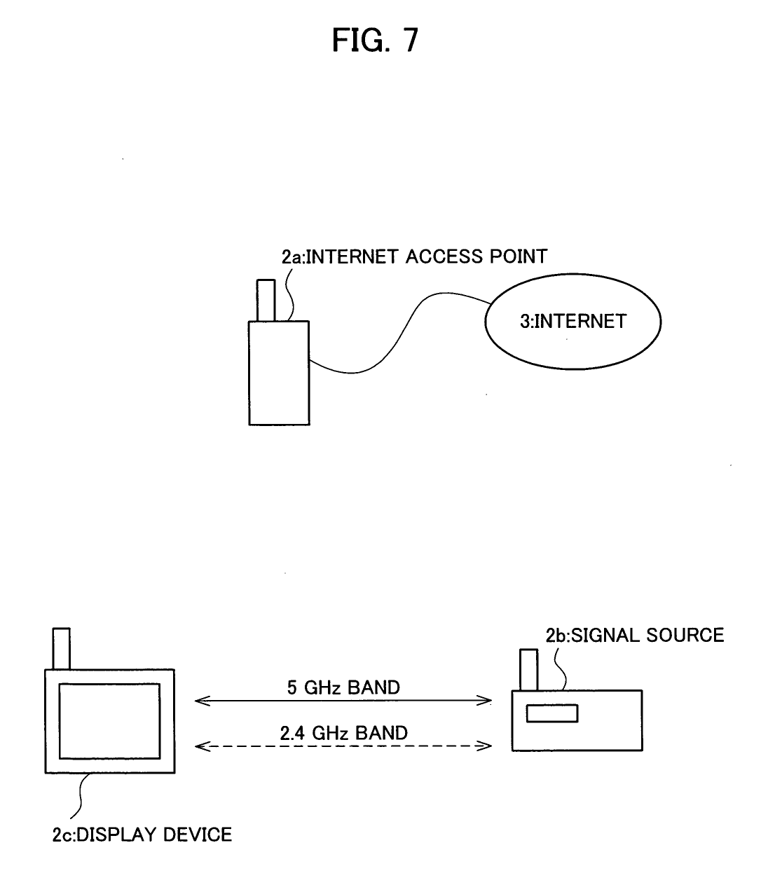

According to the foregoing structure, the first application operating section 22 shows the first radio communication section 11 for the frequency band of 5 [GHz], and as shown in the dotted line in FIG. 7, thereby starting the bi-directional communications of receiving an AV signal from the signal source 2b and transmitting the control signal to the signal source 2b.

In the foregoing example, explanations have been given through the case wherein there exists an empty channel in the frequency band 5 [GHz], and the communication state exceeds the reference, and further the link and the upper layer connection are established. However, in the case where an available channel does not exist, the communication state is lower than the reference level, or the linkage or the connection of the upper layer cannot be established, the process in S14 and the processes in and after S15 are executed, and a communication in the frequency band of 2.4 [GHz] is performed.

Specifically, in this case, the CPU 123c as the physical layer selecting section 33 maintains the OFDM modulation section 105c for the frequency band 5 [GHz] and the RF transmission section 106c to be disable, and thus the link between the signal source 2b and the display device 2c will not be established.

In this case, in order to realize the transmission of the AV signal in the frequency band (2.4 [GHz]) set for the second highest priority, the CPU 123b of the signal source 2b controls the RF receiving section 113b to determine the electric wave state at 2.4 [GHz[] to determine if there exists any available channel. If it is determined that there exists an available channel, the CPU 123b enables the OFDM modulation section 115b for the frequency band 2.4 [GHz], the OFDM demodulation section 114b, and the RF transmission section 116b in replace of the OFDM modulation section 105b for the frequency band 5 [GHz], the OFDM demodulation section 104b, and the RF transmission section 106b, thereby establishing an link with the display device 2c.

If the communication at 5 [GHz] cannot be started, as described, the display device 2c is set in the standby state for the establishment of the link from other communication device 2.

In the case, when the linkage establishment at the frequency of 2.4 [GHz] is established from the signal source 2b, compares the receiving radio field intensity as output from the receiving section 113c as the second communication state detecting section 32 corresponding to the first radio communication section 22, which is given the second highest priority as the physical layer of next to that for the first application operating section 22 with the predetermined receiving radio field intensity level (reference level) corresponding to the predetermined effective throughput for the first application operating section 22 to determine if the receiving radio field intensity exceeds the reference level.

If it is determined that the receiving radio field intensity exceeds the reference level, the CPU 123c as the physical layer selecting section 33 determines that the communication state in the frequency band 2.4 [GHz] is more desirable than the reference level, and that the second radio communication section 13 is capable of providing the effective throughput as required by the first application operating section 22. In this example, the communication of the first application operating section 22 is set in the half duplex transmission, and the CPU 123c can select the use of the second radio communication section 13 not only as the physical layer for receiving but also as the physical layer for transmitting, and the CPU 123c sets the OFDM modulation section 105c for the frequency band 2.4 [GHz] and the RF transmission section 106c to be enable.

Furthermore, the first radio communication section 11, the control section 24, and the members 101c to 106c as the first application operating section 22, the MAC section 121c, the CODEC section 124c and the CPU 123c establish a link with the signal source 2b via the radio transmission path of 2.4 [GHz] to establish the connection of the upper layer.

According to the foregoing structure, the first application operating section 22 shows the first radio communication section 11 for the frequency band of 2.4 [GHz], and as shown in the dotted line in FIG. 7, thereby starting the bi-directional communications of receiving an AV signal from the signal source 2b and transmitting the control signal to the signal source 2b.

For the frequency band of 2.4 [GHz], in the case where an available channel does not exist, the communication state is lower than the reference level, or the link or the connection of the upper layer cannot be established, the process to deal with the unusual situation in S16 shown in FIG. 6 is performed. In this case, the OFDM modulation section 105c for the frequency band 2.4 [GHz] and the RF transmission section 116c to be disable, and the display device 2c is set to the wait state. In this state, the link will not be established at any frequency band between the signal source 2b and the display device 2c.

In this case, for example, the first application operating section 22 urges for changes in positional relationship between the signal source 2b and the display device 2c by displaying a message in a display (not shown), or outputting a voice sound to a speaker via either the radio communication section 11 or 13. The first application operating section 22 then instructs the signal source 2b to reduce the quality level of the AV signal, and the radio transmission is tested again after carrying out the process of dealing with the unusual situation such as reducing the effective throughput as required to the physical layer selecting section 33.

In the foregoing preferred embodiment, explanations have been given through the case where the physical layer selecting section 33 sets the half duplex transmission in the first application operating section 22. In the case where the full duplex transmission is set, as in the case of setting the half duplex transmission, after selecting the physical layer β1 to which the priority is given (in the direction from the signal source 2b to the display device 2c in this example), the physical layer β2 in other direction is selected as a different physical layer.

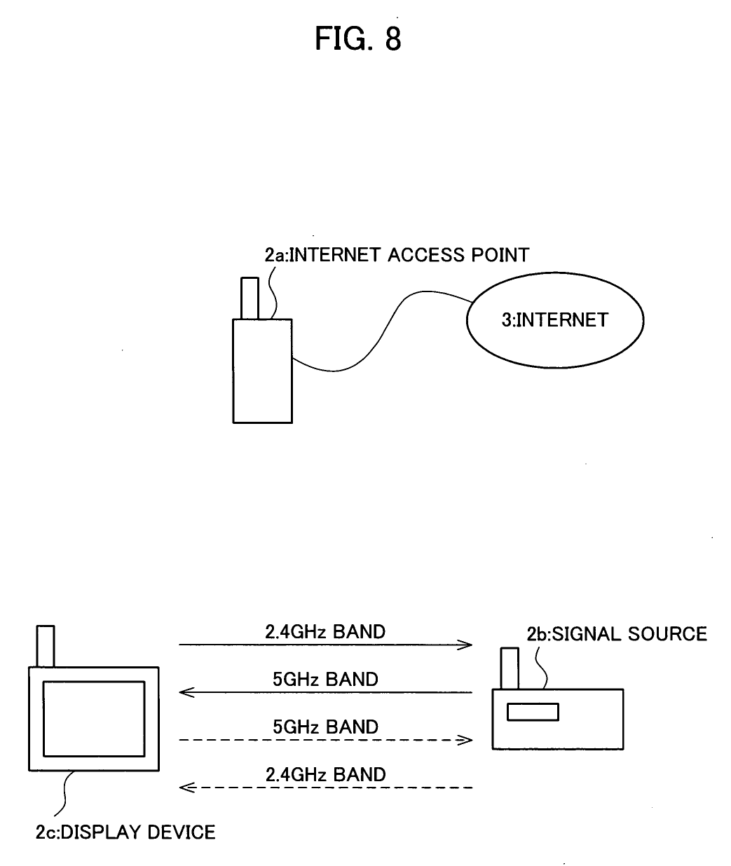

Therefore, when the communication state at the frequency band 5 [GHz] is more desirable than the reference level, as shown in the solid line in FIG. 8, the AV signal is transmitted at 5 GHz] from the signal source 2b to the display device 2c, and for the control signal transmission from the display device 2c to the signal source 2b, the frequency band of 2.4 [GHz] is used. In contrast, when the communication state at the frequency band 2.4 [GHz] is lower than the reference level, as shown in the dotted line in FIG. 8, the AV signal is transmitted at 2.4 [GHz] from the signal source 2b to the display device 2c, and for the control signal transmission from the display device 2c to the signal source 2b, the frequency band of 5 [GHz] is used.

As described, when the full duplex transmission is set, an amount of data to be transmitted is large, and the physical layer in the best communication state can be allocated to the communication direction in which a large amount of information is transmitted, and the effective throughput is need to be set higher, and it is not necessary to share the same physical layer between signals to be transmitted (various control signals, for example) in a reverse direction and the transmission of signals (AV signals, etc.) that requires high effective throughput. As a result, the QoS (Quality of Service) guarantee can be ensured more effectively in transmitting such signals as AV signals.

In many cases, the effective throughputs as required in the transmitting direction and the receiving direction are not the same, and, for example, various control signals to be transmitted in an opposite direction to the direction of mainly transmitting the signals do not require as high transmission band (physical rate that realizes a high transmission rate) as the AV signal such as voice data, etc. Therefore, in the case where the communication state is not desirable (radio field intensity required to reach the communication apparatus 2 of the receiving end), even if the physical layer for use in the transmission in an opposite direction is automatically switched to the low physical rate based on the sub carrier modulation system that can stand for a reduction in radio field intensity, the physical layer can provide the physical rate required for the transmission of signals in an opposite direction.

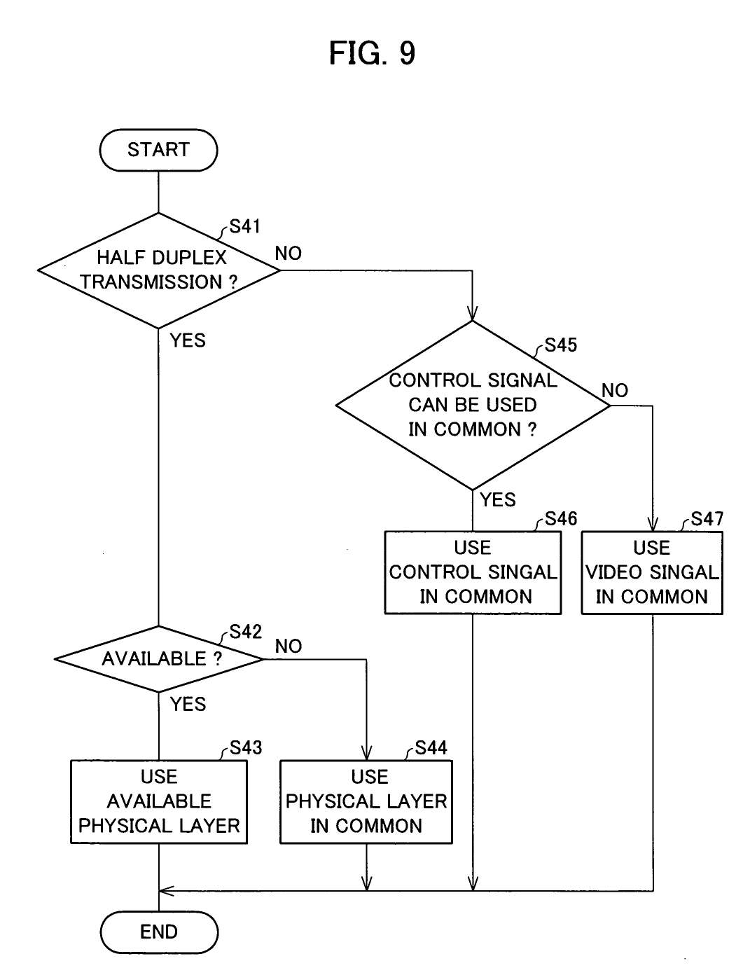

The explanations have been given through the case of transmitting and receiving signals between the communication devices in reference to FIGS. 6 to 8. In the following, explanations will be given through the case wherein the transmission of signals is started between other communication devices 2 while transmission and receiving between two communication devices are being performed in reference to FIGS. 9 to 12.

Namely, in the state where communications is being performed between the display device 2c and the signal source 2b, for example, when the physical layer selecting section 33 detects the start of the signal transmission with the communication device 2 (for example, the access point 2a) other than the display device 2c and the signal source 2b between which communications are being performed, for example, when the user instructs the second application operating section 23 to connect to the internet, in S41 of FIG. 9, the physical layer selecting section 33 confirms if there exists any available physical layer in the physical layer of the display device 2c.

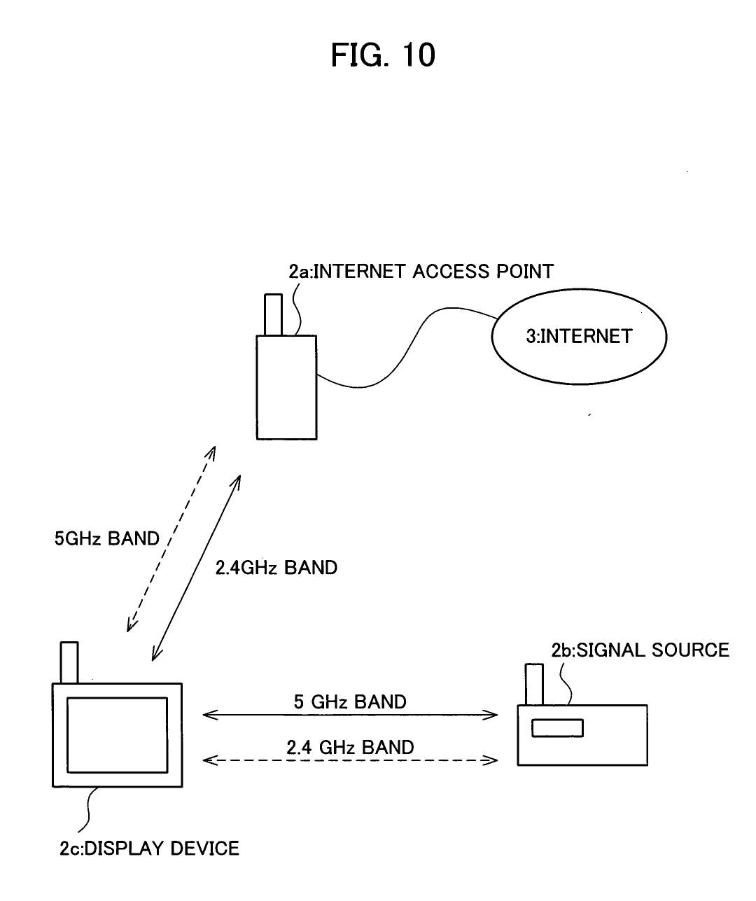

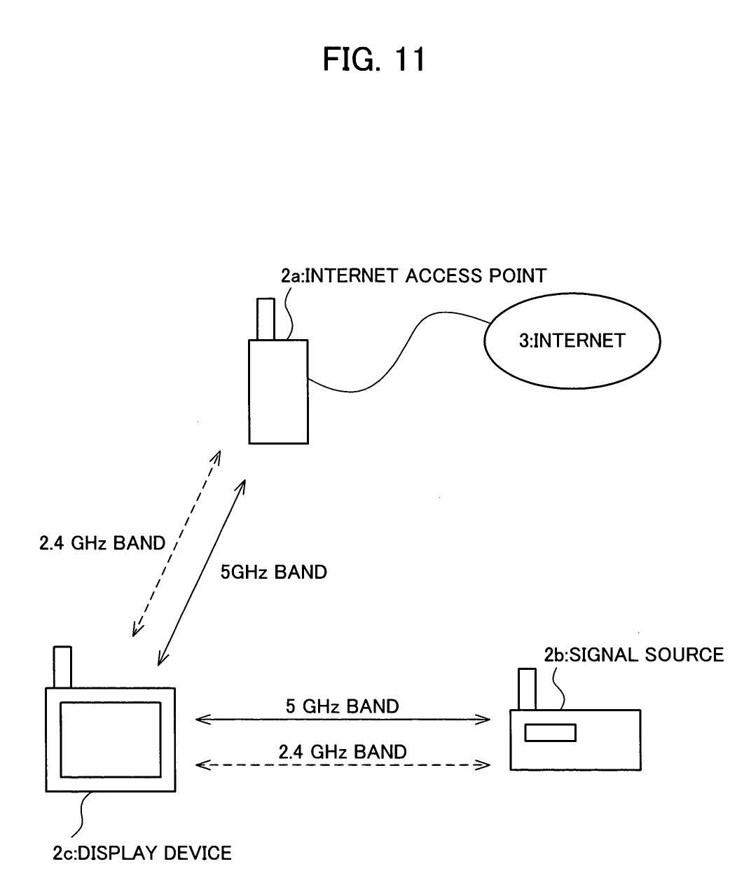

For example, in the case where any one of the physical layers β is available (YES in S41) as in the case where the half duplex transmission is performed between the display device 2c and the signal source 2b, the physical layer selecting section 33 confirms in S42 if it is possible to communicate with the access point 2a by using the physical layer β. If the physical layer selecting section 33 determines that it is possible to communicate with the access point 2a by using the physical layer β (Yes in S42), the physical layer β is selected as the physical layer, which the second application operating section 23 uses for the communication with the access point 2a (S43). As a result, as shown by the solid line or the dotted line shown in FIG. 10, the display device 2c communicates with the access point 2a via the physical layer different from the physical layer used in communicating with the signal source 2b, which started communications earlier. In FIG. 10 and FIG. 11 to be described later, the solid line indicates the case where the display device 2c communicates with the signal source 2b at a frequency band of 5 [GHz], and the dotted line indicates the case where the display device 2c communicates with the signal source 2b at a frequency band of 2.4 [GHz].

On the other hand, for example, in the case where a link is not established, or the physical layer β is not capable of providing the effective throughput as required by the second application operating section 23, etc., if the available physical layer β cannot be used (NO in S42), the physical layer selecting section 33 selects the physical layer used for communicating with the signal source 2b which started communicating earlier (S43). As a result, the physical layer 11 is shared by the communications between the display device 2c and the signal source 2b, and the communications between the display device 2c and the access point 2a.

On the other hand, for example, in the case where there exists no available physical layer (NO in S41), such as the case where the full duplex transmission is performed between the display device 2c and the signal source 2b, the physical layer selecting section 33 confirms the communication state of the physical layer β of the relatively low priority (for example, the physical layer as selected later for the full duplex transmission, or the physical layer which requires a relatively low effective throughput, etc.) from the plurality of physical layers, and determines if that physical layer β can be used for the communications with the second application operating section 23.

If it is determined that the physical layer β can be used for the communications with the second application operating section 23 (YES in S45), the second application operating section 23 selects the physical layer β as a physical layer that the second application operating section 23 uses for the communication with the access point 2a (S46). As a result, as shown by the solid line or the dotted line in FIG. 10, between the physical lasers which the display device 2c used for the communication with the signal source 2b that started communications earlier, the physical layer having the lower priority is shaped by the communications between the display device 2c and the signal source 2b and the communications between the display device 2c and the access point 2a.

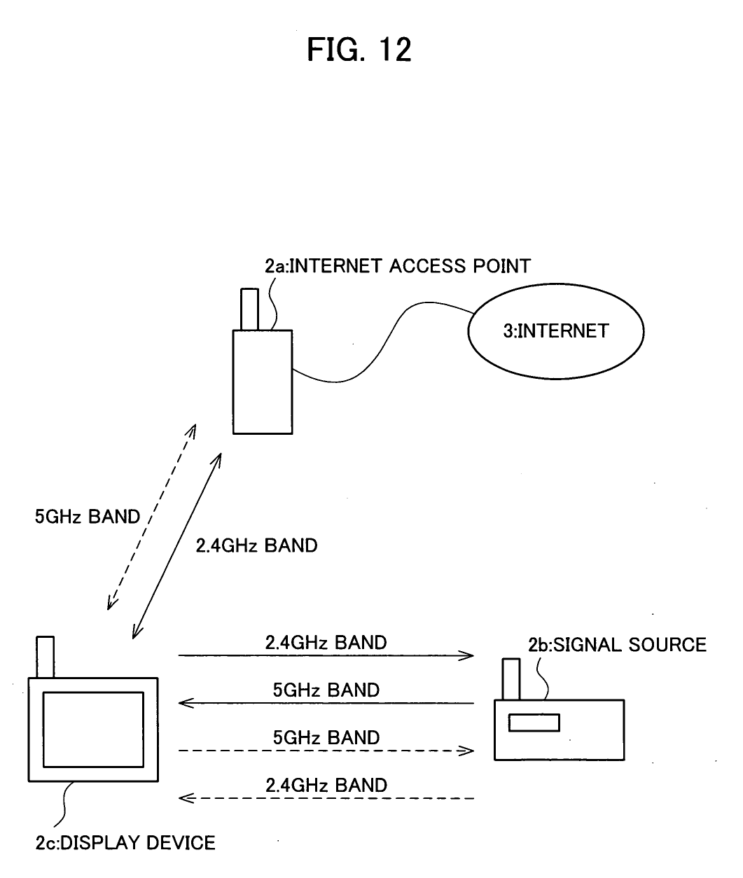

In FIG. 12, the solid line indicates the case where the display device 2c communicates with the signal source 2b at a frequency band of 5 [GHz], and the dotted line indicates the case where the display device 2c communicates with the signal source 2b at a frequency band of 2.4 [GHz]. In any case, the band for use in the transmission of the control signal is shared.

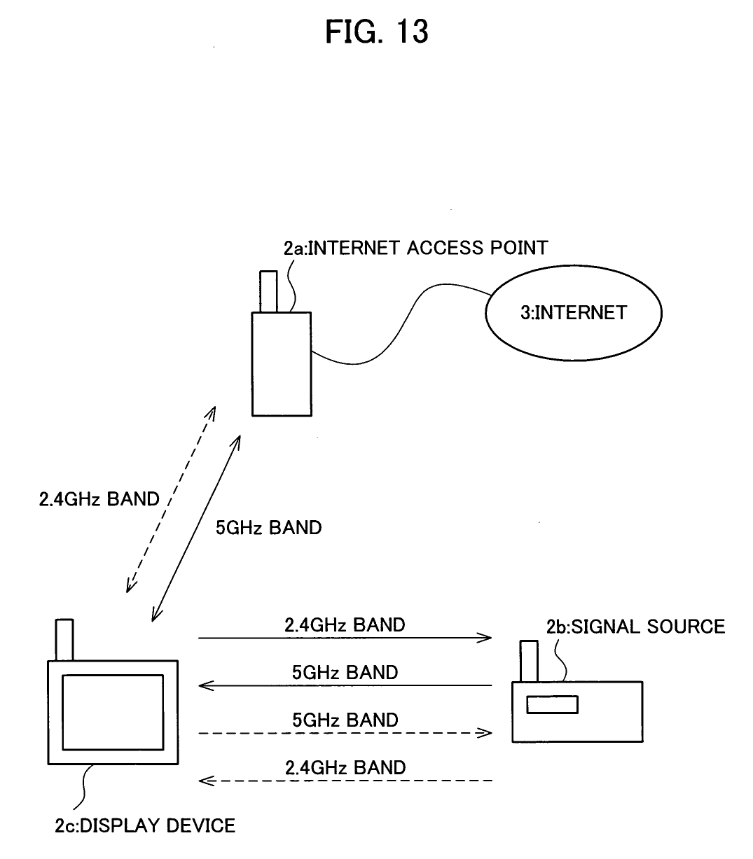

On the other hand, when it is determined that the physical layer β cannot be used for the communications with the second application operating section 23 (NO in S45), the second application operating section 23 selects the physical layer β of the second lowest priority as the physical layer which the second application operating section 23 uses for the communications with the access point 2a (S47). As a result, in FIG. 13, as shown by the solid line or the dotted line, only when the physical layer of the lowest priority cannot be used (physical layer for use in the transmission of the control signal), the physical layer of the second lowest priority (the physical layer for use in the transmission of the AV signal) is shared by the communications between the display device 2c and the signal source 2b, and the communications between the display device 2c and the access point 2a. In FIG. 13, the solid line indicates the case where the display device 2c communicates with the signal source 2b at a frequency band of 5 [GHz], and the dotted line indicates the case where the display device 2c communicates with the signal source 2b at a frequency band of 2.4 [GHz].

As described, while communications with other communication apparatus 2 (signal source 2b, for example) are being performed, the physical layer selecting section 33 of the display device 2c in accordance with the present embodiment determines if a physical layer can be used according to the priority order of a available physical layer, the physical layer of the lower priority, the physical layer of still lower priority to select the most suitable one.

With this structure, the physical layer in use for communications with the signal source 2b is used only when there is no available physical layer. It is therefore possible for the display device 2c to start the communications with the access point 2a without disturbing communications with the signal source 2b by confirming if the physical layer can be used.

Incidentally, among the physical layers in use for the communications with the signal source 2b, for example, the physical layer of high priority such as the physical layer β for transmitting the AV signal, etc., is used only when other physical layer cannot be used. It is therefore possible for the display device 2c to start the communications with the access point 2a without disturbing communications via the physical layer by confirming if the physical layer can be used.

In the case where the physical layer β transmits the necessary signal such as the AV signal, etc., when an attempt is made to use the radio frequency band of the physical layer β, it would be impossible to ensure the QoS guarantee, and, for example, a video image maybe disturbed, for example, for the AV signal, etc. In the present embodiment, however, the higher is the physical layer, the less is the factors, which hinder the QoS guarantee.

In the case where other physical layer cannot be used, the remaining physical layer is always shared; however, the present invention is not limited to the above. For example, in the case where other physical layer cannot be used, the physical layer selecting section 33 confirms if there exists any available region in the communication band of the physical layer, and then, for example, after confirming the necessary band for the communication device 2 initially used, the remaining frequency band may be used for the communications with the communication device 2.

By the way, upon selecting the physical layer for the new communication device 2 by the physical layer selecting section 33, as in the case of initially selecting the physical layer, according to the predetermined priority order, the access point 2a requests for the establishment of the link via each physical layer.

Incidentally, the access point 2a in accordance with the present embodiment determines the order of establishing a link in the following manner. That is, among physical layers which the access point 2a can use, if there exists any available physical layers not in use for the communications between other communication devices, the access point 2a requests for the establishment of a link by the physical layer. On the other hand, if there is no physical layer that can communicate at a frequency band that cannot be used for the communications between other communication devices 2, the access point 2a receives data to be transmitted at these frequency band, and, for example, makes an analysis on the radio transmission frame length and the header information, and determines the frequency band used for the transmission of the control signal. Furthermore, the access point 2a makes a request for the link establishment by the physical layer which communicates at a frequency band that is expected to be used for the control signal transmission. According to the foregoing arrangement, the access point 2a makes a request for the link establishment according to the foregoing priority order. Therefore, the higher is the priority order, the less likely that the request for the link establishment is made from the access point 2a, thereby surely ensuring the QoS guarantee.

### Second Embodiment

Explanations have been given through the case where the first and second antenna sections 12 and 14 are fixed in the first embodiment. In the present embodiment, explanations will be given through the case wherein among plural antenna sections 12 and 14, at least the one having a higher frequency is made mobile.

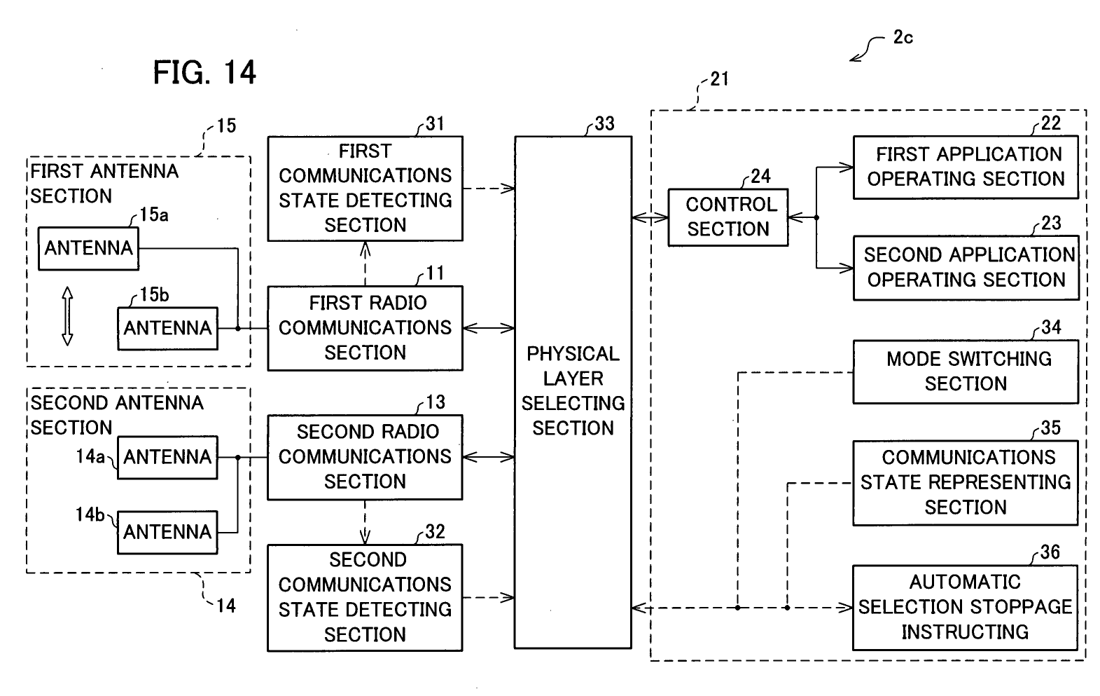

As shown in FIG. 14, the display device 2c in accordance with the present embodiment, provided is a mobile antenna section 15 in replace of the first antenna section 12. This antenna section 15 is made up of two antennas 15a and 15b, and by adopting a mobile antenna for at least one of these antennas 15a and 15b, it is possible to adjust the placement positions of the antennas 15a and 15b. In the examples shown in FIG. 14, the antenna 15a is made slidable along the peripheral portion of the display device 2c, by moving the antennas 15a, the placement positions of the antennas 15a and 15b. The first radio communications section 11 receives a signal from other communication device 2 by the diversity receiving method based on signals received by these antennas 15a and 15b.

According to the display device 2c in accordance with the present embodiment, the second antenna section 14 for 2.4 [GHz] is made up of antennas 14a and 14b, and the second radio communications section 13 receives a signal from other communication device 2 by the diversity reception method. As to the communications at the 2.4 [GHz] band, uniform transmission characteristics can be ensured in any direction. Therefore, the structure of the display device 2c of the present embodiment is simplified, and the fixed antennas are adopted in view of that if mobile antennas are adopted, the user may get confused in operating these antennas.

Although explanations have been given through the case of receiving signals from other communication device 2 by the diversity reception method, it may be arranged so as to communicate using either one of the plurality of antennas 14a and 14b by switching them. In this case, the physical layer selecting section 33 determines if the physical layer is capable of providing communications in the communication level required by the subject application in its current communication state in the following manner. That is, the first communications state detecting section 31 sequentially switches the plurality of antennas 14a and 14b to obtain respective receiving states, and the physical layer selecting section 33 then determines if the physical layer is capable of providing the communications in the communication level required by the subject application based on the results of detection.

The display device 2c in accordance with the present embodiment 2c is further provided with an automatic selection stoppage instructing section (stoppage instruction means) 36, which instructs the physical layer selecting means 33 to temporarily stop an automatic selection of a physical layer while the communication state is being adjusted.

As to the communications at frequency band of 5 [GHz], the receiving state may be changed significantly depending on the installation state of antenna, for example, in indoors as the communications are performed using the very linear electric wave.

In view of the foregoing, according to the structure of the present embodiment, for the first antenna section 15 whose communications state is subjected to a relatively large change depending of the installation state of antenna, a mobile antenna is adopted, so that its installation place can be changed. According to the foregoing structure, by adjusting the placement position of antenna, the communication state can be improved, thereby permitting communications in more desirable communications state.

While the placement position of the antenna is being adjusted, the communication state is subjected to change. Therefore, if the physical layer selecting section 33 selects the physical layer for use in communicating based on the communication state of the physical layer being moved, the physical layer as selected may not be the optimal one in the condition after the placement position of the antenna has been adjusted.

According to the display device 2c in accordance with the present embodiment, as the automatic selection stoppage instructing section 36 is provided, and the automatic selection stoppage instructing section 36 instructs the physical layer selecting section 33 to stop the automatic selection of the physical layer while the placement position of the first antenna section 15 is being adjusted, for example, in response to an operation from the user, a movement of the antenna 15a, etc. It is therefore possible to prevent a wrong selection of the optimal physical layer. As a result, the physical layer selection means can more appropriately select the optimal physical layer for the current communications state.

As described, the display device 2c in accordance with the present embodiment is provided with a communication state presenting section 35, which presents a communication state of each of the plurality of layers. According to this structure, the user of the display device 2c can see the communication state of each physical layer for the current position of the antenna, and thus it is possible for the user to adjust the placement position of the antenna so as to ensure the desirable communications state.

In the foregoing preferred embodiments, explanations have been given through the case where each of the application operating sections 22 and 23, or the mode switching section 34 sets the physical layer selecting section 33 all the parameters of a mode, an effective throughput, a priority order and full/half transmission; however, the present invention is not limited to the above, and an effect of the present invention can be achieved to some extent as long as at least one of the above parameters can be set.

However, by arranging such that all the parameters can be set in the physical layer selecting section 33, the physical layer selecting section 33 can select the physical layer most suited for each of the application operating sections 22 and 23 in the current communication state as in the case of the foregoing preferred embodiments.

In the foregoing preferred embodiments, explanations have been given through the case where the communication device 2 has two physical layers; however, the number of the physical layers is not limited to two, and the number of the physical layers can be selected as desired.

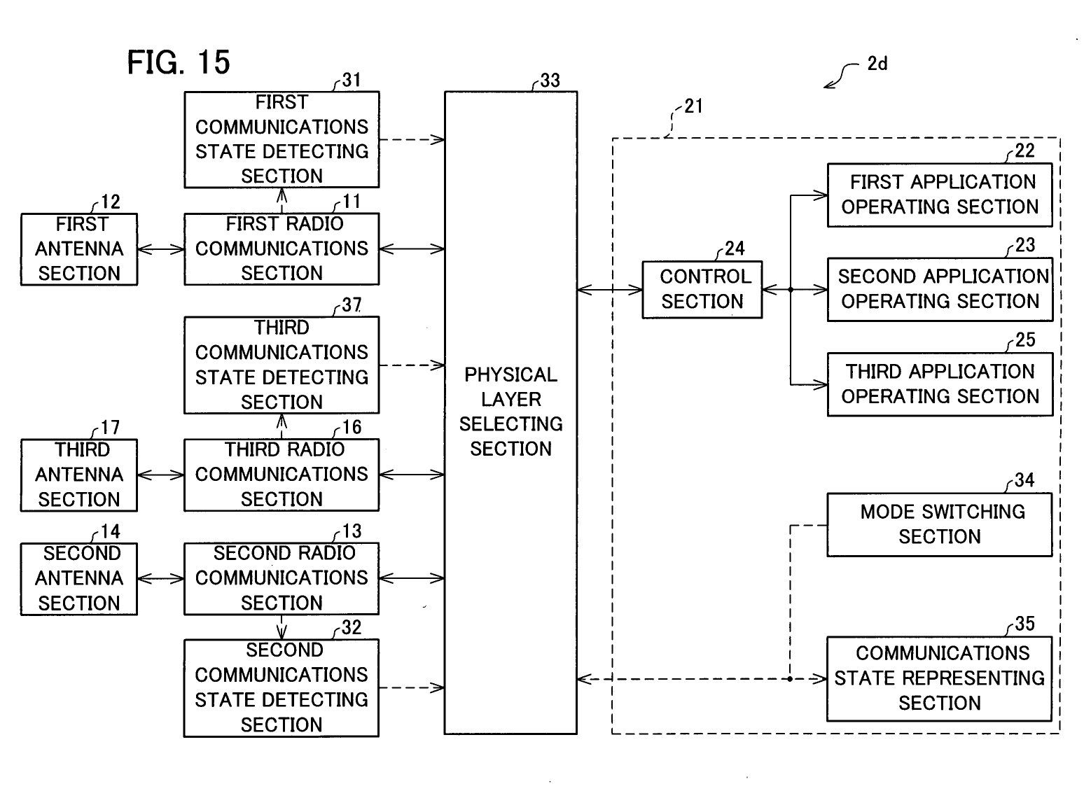

For example, FIG. 15 shows the communication device 2 (display device 2d), which is suitably used as a display device for a game machine, etc. The display device 2d in accordance with the present embodiment substantially has the same structure as the display device 2c shown in FIG. 1. The display device 2d of the present embodiment has a similar structure to that of the display device 2c shown in FIG. 1, except that the display device 2d is further provided with the third radio communications section 16 as a third physical layer which communicates at 60 [GHz] band and the third antenna section 17, and the third communications state detecting section 37 for detecting the communications state of the third radio communications section 16. Among the three physical layers, the physical laser selecting section 33 selects a physical layer for use in communicating by each of the application operating sections in a data processing section 21 based on the results of detections by the communications state detecting sections 31, 32 and 33.

The display device 2d in accordance with the present embodiment is further arranged such that the data processing section 21 has a third application operating section 25 which requires a wider band QoS guarantee as compared to the case of displaying an AV signal stored in the signal source 2b. This third application operating section is realized, for example, by an application for game, etc.

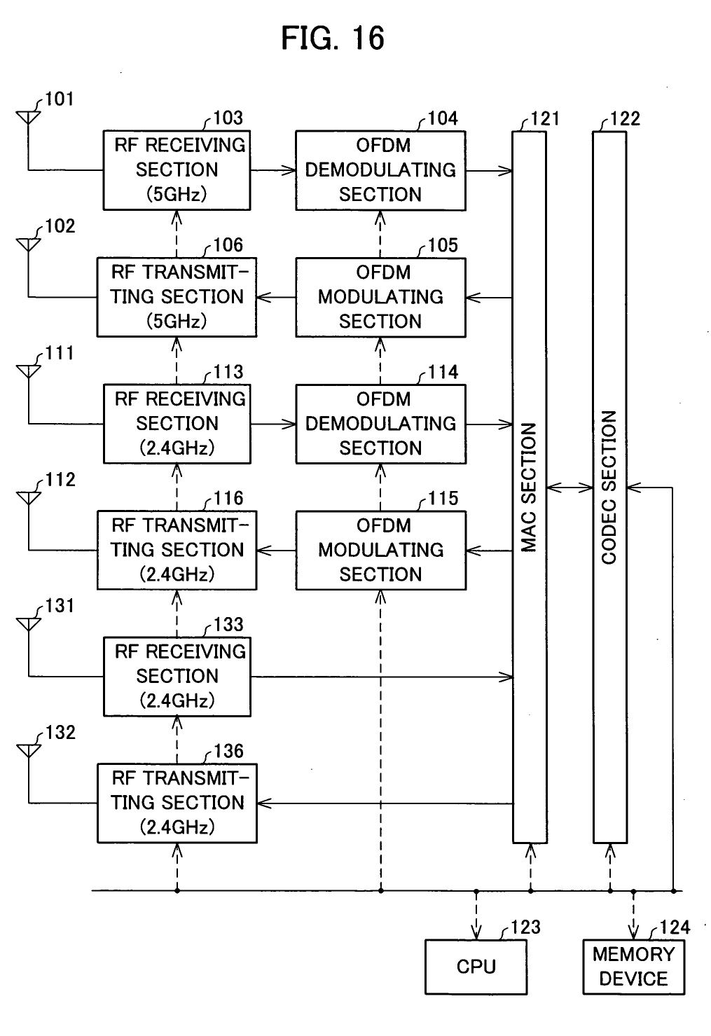

For example, as illustrated in FIG. 16, the third antenna section 17 is made up of the antenna sections 131 and 132 capable of transmitting and receiving efficiently in 60 [GHz] band. The display device 2d is provided with an RF receiving section 133 and an RF transmitting section 136 as the third radio communications section 16. The RF receiving section 133 is provided for outputting the digital data string as a base band string to the control section 24 by down converting a signal (60 [GHz]) in a radio transmission frequency band ass received by the antenna section 131. The RF transmitting section 136 generates a signal in the radio transmission frequency band by up converting the digital data string from the control section 24, to be transmitted from the antenna section 132. In the foregoing third communications section 16, the OFDM modulation/demodulation section for modulating/demodulating at a base band to reduce a delay time is omitted unlike the case of the first radio communications section 11 and the second radio communications section 13.

For example, assumed that the data rate of an AV signal (AV signal for games, etc.) to be transmitted without causing any error be 24 [Mbps], and the data rate required for an over head such as a header, a control signal, etc., be 30 [Mbps]. Then, the basic wave frequency of a base band signal would be 30/2=15 [MHz]. Therefore, assumed further for a high harmonic wave components, nine times wave frequency, the band to be ensured would be 15×9=135 [MHz], and to be safe, the required frequency would be 150 [MHz]. Here, for the 2.4 [GHz] band or 5[GHz] band, it would be technically difficult to realize a transmission in a wide band due to regulations in using channels, or regulations in radio law. However, as in the third radio communications section 16, by utilizing the radio physical layer in 60 [GHz] band, a wide band, say, 150 [MHz] can be realized.

According to the foregoing structure, the physical layer selecting section 33 selects a physical layer for each application operating section to use in communicating according to the current communicate state of each physical layer. As a result, even when a communication state of each physical layer changes with time, and the communication quality level of each physical layer changes with time accordingly, it is still possible to select an optimal physical layer that permits each application to communication in the current communications state.

In particular, in the present embodiment, adopted as one of the physical layers is a physical layer in which a base band modulation/demodulation is omitted, and which permits a base band direct transmission. For the QoS guarantee, even when adopting the application operating section which requires a delay in signal to be suppressed to the minimum, by selecting the above physical layer, it is possible to realize communications without generating a delay in the radio physical layer adopting a modulation/demodulation block. Incidentally, in the case where the communications state of the physical layer is not desirable, another physical layer may be adopted, if any, and if not, it is possible to urge the application to lower the communication quality level to be requested to deal with the situation.

In the foregoing preferred embodiments, explanations have been given through the case of adopting the physical layer selecting section 33 in the display device 2c (2d); however, the communication device 2 to be provided in the physical layer selecting section 33 is not limited to such display device. The physical layer selecting section 33 may be provided in other communication device 2, for example, in a television receiver, a personal computer, a portable telephone, a PDA (Personal Digital Assistant), or other vide receiving device, or a video recorder, a hard disk recorder or other video storage device, or a home server, a residential gateway, a DVD player, a hard disk player, or a video transmitting device, etc.

In each of the foregoing preferred embodiments, a part of each member which constitutes a communication device 2, has been explained as a functional block realized by executing a program stored in a ROM, RAM, or recording medium, by the CPU or the arithmetic means. However, it can be realized, for example, by a hardware, which performs the corresponding process, or may be realized by a combination of the hardware, which performs a part of the process and the arithmetic means which executes the program for controlling the hardware or executing the remaining process. Even the members of each communication device which have been explained as hardware may be realized by a combination of the hardware which performs a part of the process and the arithmetic means which executes the program for controlling the hardware or executing the remaining process. Incidentally, the foregoing program may be executed by the arithmetic means of a single unit, or by a plurality of units connected via bus in the device or via communication paths of various types.

The foregoing program is provided, for example, in a recording medium storing the program itself or the program data indicative of the data for use in the preparation of the program, or by transmitting the program data by means of wired or radio communications means, to be executed by the arithmetic means.

It is not necessarily but preferable that the recording medium for providing the program data be detachable. After providing the program data, however, whether or not the recording medium is detachable does not make a difference. As long as the program data is stored, the present invention does not specify the recording medium, whether re-writable or not, volatile or not, nor specifies the recording method of the program data or the shape of the recording medium. Non-limited examples of the recording medium includes a magnetic tape or cassette tape or other tape, or a floppy (registered mark) disk, a hard ware, or other magnetic disk, or a CD-ROM, a magneto-optical disk (MO), mini disk (MD), a digital video disk (DVD), or other disk. The recording medium is an IC card, an optical card, etc., a mask ROM, EPROM, EEPROM, or a flash ROM, or other semiconductor memory.

The program data may be codes for use in instructing all the steps in each of the foregoing processes to the arithmetic means, or if a basic program which executes at least some of the steps if each process (operating system, library, etc.) by calling a predetermined steps, some or all the program data may be rewritten by codes or a pointer for use in instructing the arithmetic means to call the basic program.

The program data may be stored in the recording medium so as to be executable by the arithmetic means such as a real memory, etc., or may be stored in a format before being stored in the real memory and after being installed in a local recording medium (such as a real memory, a hard disk, etc.) so that the arithmetic means can access any time. The program data is not limited to the object code after being complied, and may be source codes, or intermediate codes to be generated in the process of interpreting or compiling. In any case, similar effects can be achieved irrespectively of the storage format of the program data in the recording medium as long as convertible in a format executable by the arithmetic means by a process of decompressing, decoding, interpreting, compiling, linking or storing in a real memory, alone or a combination of the above processes.

As described the communication device in accordance with the present embodiment is characterized by including:

a plurality of physical layers;

memory means for storing a communication quality level required by an application; and

physical layer selecting means for selecting among the plurality of physical layers, a physical layer currently capable of providing communications in the communication quality level required by the subject application, as a physical layer for the subject application to use in communicating. In the foregoing structure of the communication device, the communication quality level is determined, for example, by an effective throughput, a response time, a transmission rate of the physical layer or a receiving radio field intensity.

According to the foregoing structure, the memory means stores the communication quality level required by an application; and the physical layer selecting means selects among the plurality of physical layers, a physical layer currently capable of providing communications in the communication quality level required by the subject application. According to the foregoing structure, even when a communication state of each physical layer changes with time, and the communication quality level of each physical layer changes with time, it is still possible to select an optimal physical layer that permits each application to communication in the current communications state.

The communication device having the foregoing structure may be arranged such that:

in the case where none of the physical layers is capable of providing communications in the quality level required by the subject application, the physical layer selecting means informs that to the subject application to urge it to lower the communication quality level to be required.

According to the foregoing structure, in the case where none of the physical layers is capable of providing communications in the quality level required by the subject application, the physical layer selecting means informs that to the subject application to urge it to lower the communication quality level to be required. Incidentally, when the communication quality level is lowered, the physical layer selecting means selects a physical layer providing communications in the required quality level as lowered.

According to the foregoing structure, in the case where a sufficient communication quality for the transmission of a quality video signal cannot be ensured, the subject application can reduce the communication quality level to be requested to the physical layer selecting means, a level by a level, according to the current communication state.

The communication device having the foregoing structure may be further arranged such that:

the physical layer selecting means determines a current communication state of each of the plurality of physical layers according to a predetermined priority order set beforehand from that of the highest priority if it is capable of providing communications in the communication quality level required by the subject application, and selects the physical layer capable of providing communications in the communication quality level if any.

According to the foregoing structure, the physical layer of the lowest priority is selected only when all the other physical layers of the higher priority are not capable of providing the communication quality level as requested. It is therefore possible to omit the unnecessary process of confirming the communication quality unlike the structure of determining each physical layer if it is capable of providing communications in the communication quality level as requested. As a result, interference to other communications due to the detection of the communication state can be prevented.

Incidentally, it is not necessarily but preferable that that all the physical layers communicate via the wired communication path, and the plurality of physical layers may include the physical layer which communicates via the radio communication path.

The communication device having the foregoing structure may be arranged such that the plurality of physical layers include a physical layer which communicates via the radio communication path, using a radio frequency band of either 2.4 [GHz] band or 5 [GHz] band. The communication device having the foregoing structure may be further arranged such that at least one of the plurality of physical layers that communicates via the radio communication path is provided with a plurality of antennas, and when determining a current communication state of each of the plurality of physical layers if it is capable of providing communications in the communication quality level as required by the subject application, the physical layer selecting means switches an antenna among the plurality of antennas in order to obtain respective receiving states, and determines the current communication state of each of the plurality of physical layers based on a receiving state.

In the case of communicating via the radio communication path, the communication distance between the communication devices is more liable to change and the interference with the communication by other communication devices and the interference from a noise source are more liable to occur as compared to the case of communicating via the wired communication path.

According to the foregoing structure, the memory means stores the communication quality level required by an application; and the physical layer selecting means selects among the plurality of physical layers, the physical layer currently capable of providing communications in the communication quality level required by the subject application. According to the foregoing structure, even when a communication state of each physical layer changes with time, and the communication quality level of each physical layer changes with time, it is still possible to select an optimal physical layer that permits each application to communication in the current communications state.

The communication device having the foregoing structure may be further arranged such that the physical layer that communicates via the radio communication path is provided in plural number, and a physical layer having a highest radio frequency of the plurality of physical layers is provided with a mobile antenna that permits its installation position to be changed. Incidentally, not only the physical layer of the highest radio frequency band but also other physical layers may be provided with the mobile antenna.

According to the foregoing structure, the communications are performed using the physical layer of the highest radio frequency band, by high frequency and very linear electric wave, and in response, the physical layer whose communication state is most liable to change by the placement position of the antenna is provided with a mobile antenna. As a result, it is possible to improve the communication state by adjusting the placement position of the antenna.

The communication device having the foregoing structure may be arranged such that:

at least one of the plurality of physical layers that communicates via the radio communication path includes a mobile antenna that permits its installation position to be changed, and

the communication device further comprising:

stoppage instruction means for temporally stopping the operation of selecting the physical layer by the physical layer selecting means while the placement position of the mobile antenna is being adjusted.

While the placement position of the antenna is being adjusted, the communication state is subjected to change. Therefore, if the physical layer selecting means selects the physical layer for use in communicating based on the communication state of the physical layer being moved, the physical layer as selected may not be the optimal one in the condition after the placement position of the antenna has been adjusted.

According to the foregoing structure; however, the automatic selection of the physical layer by the physical layer selecting means is stopped while the placement position of the mobile antenna is being adjusted. It is therefore possible to prevent a wrong selection of the optimal physical layer. As a result, the physical layer selection means can more appropriately select the optimal physical layer.

The communication device having the foregoing structure may be arranged such that:

the plurality of physical layers include plural physical layers that communicate via the radio communication path, and

the priority order of these physical layers is set such that the higher is the radio field frequency, the higher is the priority order.

According to the foregoing structure, the higher is the physical layer, i.e., the longer is the communication distance, the worse is the communication state; on the other hand, the physical layer that is less likely to have an interference from other apparatus and is capable of providing quality communication is preferentially selected. Therefore, in the area wherein communication can be performed at a short distance, using a high frequency physical layer, it is possible to stabilize the communication quality by communicating by the physical layer. On the other hand, in the area wherein the communication distance is long, and physical layer of high frequency cannot be used, a physical layer of lower frequency, which permits the longer distance communications is selected. As a result, as compared to the structure of adopting only the physical layer of low frequency, the communication quality level for the short distance communication can be more stabilized, and as compared to the structure of adopting only the high frequency physical layer, it is possible to increase the area in which the communications can be performed in the communication quality level requested by the application.

The priority order may be set in common among the plurality of applications; however, it may be set for each application. Specifically, the communication device having the foregoing structure may be arranged such that:

the memory means stores the priority order of the plurality of physical layers independently for each application, and

upon selecting a physical layer for the application to use in communicating, the physical layer selecting means reads out the priority order of the application from the memory means and selects the physical layer according to the priority order.

According to the foregoing structure, the priority order can be set for each application. It is therefore possible to select the physical layer most suited for the application in the current communication state. For example, it the case of the application which required a bond guarantee, and disturbances in transmission rate due to the interference is suppressed to the lowest possible limit, the higher is the frequency, the higher priority is set. On the other hand, in the case of the application, which is not adversely affected by the disturbance in transmission rate, such as the application which does not require the band guarantee, the lower is the frequency, the higher priority is set. In this way, it is possible to communicate by the physical layer which offers communicates in communication quality level as required without disturbing the data transmission and receiving of the application which requires the band bond guarantee.

The communication device having the foregoing structure may be arranged such that:

the physical layer selecting means selects a physical layer for the subject application to use in both directions of transmitting and receiving.

According to the foregoing structure, the same physical layer is adopted in both directions of transmitting and receiving, and thus the communication by the subject application is less likely to interfere the communications by other applications.

The communication device having the foregoing structure may be arranged such that:

the physical layer selects the first physical layer for use in transmitting a signal in a transmitting direction or a receiving direction which is mainly used, at least one of the plurality of physical layers that communicate via the radio communication path are provided with a plurality of antennas, and selects from other physical layers than the second physical layer for use in signal transmission in other direction. According to the foregoing structure, the physical layer for use in transmitting is different from the physical layer for use in receiving. It is therefore possible to offer a wider band for the application.

Incidentally, whether or not the same physical layer is used for both directions of receiving and transmitting may be set in common among the plurality of applications, but may be set for each application. Specifically, the communication device having the foregoing structure may be arranged such that the memory means stores a transmission method of either full-duplex transmission or half-duplex transmission to be adopted for each application; and in the case where the stored transmission method for the subject application is a half duplex transmission, the physical layer selecting means selects a physical layer for both transmitting and receiving directions to be used for the application; while, in the case where the transmission method stored for the subject application is a half duplex transmission, the physical layer selecting means selects a physical layer for use in transmitting a signal in either a transmitting direction or a receiving direction which is mainly used, and selects from other physical layer than the physical layer for use in transmitting a signal in the mainly used direction, for use in transmitting a signal in the other direction.

According to the foregoing structure, whether the half-duplex transmission or the full-duplex transmission is to be adopted may be set for each application. As a result, it is possible to select the physical layer most suited for the application.

The communication device having the foregoing structure may be arranged such that:

the physical layer selecting means is provided with physical layer fixing means which makes the physical layer selecting means select a predetermined physical layer for the subjection application to use in communicating, irrespectively of a communication state.

According to the foregoing structure, the physical layer fixing means makes the physical layer selection means select the predetermined physical layer according to the kind of the application or an instruction given by the user. As a result, the interference to the radio frequency band to be used for other communications, which require QoS guarantee can be prevented.

The communication device having the foregoing structure may be arranged such that:

the physical layer fixing means makes the physical layer selecting means select the predetermined physical layer only when the subject application does not require the band guarantee.

According to the foregoing structure, the physical layer fixing means makes the physical layer selection means select the predetermined physical layer only when the subject application does not require the band grantee. As a result, the interference to the radio frequency band to be used for the communications, which require other QoS guarantee can be prevented.

The communication device having the foregoing structure is arranged such that:

in the case where the subject application starts communicating with a second correspondent different from a first correspondent which is a current correspondent of the subject application, the physical layer selecting means selects from the plurality of physical layers, a physical layer not in use by the subject application, as a physical layer for use in communicating with the second correspondent.

According to the foregoing structure, for the communications with the second correspondent, the physical layer not used for the communications with the second correspondent is selected. As a result, it is possible to communicate with the second correspondent without disturbing the communications with the first correspondent.

It is preferable that the communication device having the foregoing structure be arranged such that:

in the case where the physical layer as selected for use in communicating with the second correspondent cannot be used, the physical layer selecting means selects the physical layer in use for communicating with the first correspondent to be used in common between the first correspondent and the second correspondent.

According to the foregoing structure, in the case where the physical layer as selected for use in communicating with the second correspondent cannot be used, the physical layer selecting means selects the physical layer in use for communicating with the first correspondent to be used in common between the first correspondent and the second correspondent. As a result, it is possible to more surely communicate with the second correspondent. Incidentally, in the case where communications can be performed without disturbing the communications with the second correspondent by the available physical layer, that available physical layer is used. Therefore, it is less likely to disturb the communications with the first correspondent.

It is preferable that the communication device having the foregoing structure be arranged such that:

in the case where the subject application starts communicating with a second correspondent different from a first correspondent to which the subject application is communicating, the physical layer selecting means selects between the first physical layer in use by the subject application and the second physical layer, the second physical layer to be used in common between the first correspondent and the second correspondent.

According to the foregoing structure, when communicating with the second correspondent, the second physical layer is used in common. As a result, it is possible to communicate with the second correspondent without disturbing communications in the direction of transmitting or receiving which is mainly used (the communication direction by the first physical layer).

It is preferable that the communication device having the foregoing structure be further arranged such that:

in the case where the physical layer as selected for use in communicating with the second correspondent cannot be used, the physical layer selecting means selects the first physical layer to be used in common between the first correspondent and the second correspondent.

According to the structure, in the case where the physical layer selected for the communications with the second correspondent cannot be used, the first physical layer is used in common. As a result, it is possible to more surely communicate with the second correspondent. Incidentally, in the case where communications can be performed by the second physical layer without disturbing the second correspondent, the second physical layer is used. Therefore, it is less likely to disturb communications in the mainly used direction, i.e., either transmitting or receiving can be performed.

It is preferable that the communication device having the foregoing structure be further arranged so as to include: communication state presenting means which presents a communication state of each of the plurality of layers, for example, by outputting a voice sound, or displaying the communication state.

The communication device having the foregoing structure may be further arranged so as to include: communication state presenting means which presents a communication state of each of the plurality of layers, for example, by outputting a voice sound, or displaying the communication state. According to this structure wherein the communications state of each physical layer is presented, it is possible to urge the subject application to improve the communication state, for example, by adjusting the variable factors in the communication device if the current communication state is not desirable. Incidentally, in the case where the physical layer communicates via the radio communication path, by moving the communications device or adjusting the antenna, it is possible to improve the communication state with ease as compared to the case of adopting the wired line. As described, the foregoing structure of presenting the communication state of each physical layer can be fully appreciated.

The communication device having the foregoing structure may be further arranged such that in the case of adopting a plurality of applications, the communication state presenting means presents if a communication state of each physical layer is capable of providing communications in the communication quality level required by each application.

According to the foregoing structure wherein the communication state presenting means presents if a communication state of each physical layer is capable of providing communications in the communication quality level required by each application, the user can see if each physical layer is capable of providing communications as requested by each application without recognizing the communication quality level requested by each application, and thus can take an appropriate action.

The communication device having the foregoing arrangement may be arranged such that the communication state presenting means presents not only the communication state of each of the plurality of physical layers but also the physical layer being selected by the physical layer selecting means. According to the foregoing structure, since the physical layer currently being selected is presented for the user, the user can surely recognize the communication state of the physical layer in use.

The communication device having the foregoing structure may be arranged such that:

the communication state presenting means presents the communication state together with a display by the application. According to the foregoing structure, the communication state is displayed together with the display by the application. As a result, the user needs not check the communication state by switching the display by the application, and can recognize the communication state with a simpler manner.

The communication device having the foregoing arrangement may be arranged such that:

the communication device is a video receiving device or a video storage device. Non limited examples of the video receiving device include a television receiver, a personal computer, a portable telephone, a PDA (Personal Digital Assistant), etc. None limited examples of the video memory device include a video recorder, a hard disk recorder. The communications device may be a video transmitting device. Non-limited examples of the video transmitting device include a home server, a residential gateway, a DVD player, a hard disk recorder, etc.

The foregoing communication devices required communications with band guarantee in transmitting or receiving a video signal, the effect of providing the physical layer selecting means can be fully appreciated.

The foregoing communication device may be realized by a hardware, or may be realized by making a computer execute the program. Specifically, the communication device may be realized by the program, which makes a computer operate as:

memory means for storing a communication quality level required by an application; and

physical layer selecting means for selecting among the plurality of physical layers, a physical layer currently capable of providing communications in the communication quality level required by the subject application, as a physical layer for the subject application to use in communicating. The recording medium in accordance with the present invention stores the foregoing program.

Upon executing the program by the computer, the computer operates as the communication device. Therefore, together with the communication device, the communication state by each physical layer changes with time, and accordingly, even when the communication quality level offered by each physical layer changes with time, it is possible for each application to communicate by using the physical layer optimal for the current communication state.

In order to achieve the foregoing object, the communication device in accordance with the present embodiment is characterized by including:

a plurality of physical layers;

memory means for storing a communication quality level required by an application; and

physical layer selecting means for selecting among the plurality of physical layers, a physical layer currently capable of providing communications in the communication quality level required by the subject application, as a physical layer for the subject application to use in communicating. The program in accordance with the present invention is a program to be realized by the communication device, and the recording medium in accordance with the present invention stores the program. Upon executing these programs by the computer, the computer operates as the communication device. In the foregoing structure of the communication device, the communication quality level may be determined, for example, by an effective throughput, a response time, a transmission rate of the physical layer or a receiving radio field intensity.

According to the foregoing structure, the memory means stores the communication quality level required by the application; and the physical layer selecting means selects among the plurality of physical layers, a physical layer currently capable of providing communications in the communication quality level required by the subject application. According to the foregoing structure, even when a communication state of each physical layer changes with time, and the communication quality level of each physical layer changes with time accordingly, it is still possible to select an optimal physical layer that permits each application to communication in the current communications state.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

1. A communication device, comprising:
a plurality of physical layers;
memory means for storing a communication quality level required by a subject application; and
physical layer selecting means for selecting among said plurality of physical layers, a physical layer currently capable of providing communications in the communication quality level required by the subject application, as a physical layer for the subject application to use in communicating.

2. The communication device as set forth in claim 1, wherein:
said communication quality level is determined by an effective throughput, a response time, a transmission rate of the physical layer or a receiving radio field intensity.

3. The communication device as set forth in claim 1, wherein:
in the case where none of the physical layers is capable of providing communications in the quality level required by the subject application, said physical layer selecting means informs that to the subject application and requests that the subject application lower the required communication quality level.

4. The communication device as set forth in claim 1, wherein:
said physical layer selecting means determines a current communication state of each of said plurality of physical layers according to a predetermined priority order set beforehand from that of the highest priority if it is capable of providing communications in the communication quality level required by the subject application, and selects the physical layer capable of providing communications in the communication quality level if any.

5. The communication device as set forth in claim 1, wherein:
said plurality of physical layers include a physical layer for use in communicating via a radio communication path.

6. The communication device as set forth in claim 5, wherein:
said plurality of physical layers include a physical layer which communicates via the radio communication path, using a radio frequency band of either 2.4 GHz band or 5 GHz band.

7. The communication device as set forth in claim 5, wherein:
at least one of said plurality of physical layers that communicates via the radio communication path is provided with a plurality of antennas, and
when determining a current communication state of each of said plurality of physical layers if it is capable of providing communications in the communication quality level as required by the subject application, said physical layer selecting means switches an antenna among said plurality of antennas in order to obtain respective receiving states, and determines the current communication state of each of said plurality of physical layers based on a receiving state.

8. The communication device as set forth in claim 5, further comprising:
a plurality of physical layers which communicate via the radio communication path wherein
a physical layer, of the plurality of physical layers which communicate via the radio communication path, having a highest radio wave frequency is provided with a mobile antenna having an adjustable installation position to be changed.

9. The communication device as set forth in claim 5, wherein:
said physical layer that communicates via the radio communication path includes a mobile antenna having an adjustable installation position, and
said communication device further comprising:
stoppage instruction means for temporally stopping the operation of selecting the physical layer by said physical layer selecting means while the installation position of the mobile antenna is being adjusted.

10. The communication device as set forth in claim 4, wherein:
said plurality of physical layers include plural physical layers that communicate via a radio communication path, and
the priority order of the physical layers that communicate via the radio communication path is ordered from highest to lowest radio field frequency.

11. The communication device as set forth in claim 3, wherein:
said memory means stores the priority order of said plurality of physical layers independently for each of a plurality of subject applications, and
upon selecting a physical layer for the application to use in communicating, said physical layer selecting means reads out the priority order of the application from the memory means and selects the physical layer according to the priority order.

12. The communication device as set forth in claim 1, wherein:
said physical layer selecting means selects a physical layer for the subject application to use in both directions of transmitting and receiving.

13. The communication device as set forth in claim 1, wherein:
said physical layer selects the first physical layer for use in transmitting a signal in a transmitting direction or a receiving direction, at least one of said plurality of physical layers communicate via a radio communication path and are provided with a plurality of antennas, and selects from other physical layers than the first physical layer for use in signal transmission in other direction.

14. The communication device as set forth in claim 1, wherein:
said memory means stores a transmission method of either full-duplex transmission or half-duplex transmission to be adopted for each application; and
in the case where the stored transmission method for the subject application is a full duplex transmission, said physical layer selecting means selects a physical layer for both transmitting and receiving directions to be used for the application; while, in the case where the transmission method stored for the subject application is a half duplex transmission, said physical layer selecting means selects a physical layer for use in transmitting a signal in either a transmitting direction or a receiving direction which is mainly used, and selects from other physical layer than the physical layer for use in transmitting a signal in the mainly used direction, for use in transmitting a signal in the other direction.

15. The communication device as set forth in claim 1, wherein:
said physical layer selecting means is provided with physical layer fixing means which controls said physical layer selecting means to select a predetermined physical layer for the subjection application to use in communicating, irrespective of a communication state.

16. The communication device as set forth in claim 15, wherein:
said physical layer fixing means controls said physical layer selecting means to select the predetermined physical layer only when the subject application does not require a band grantee.

17. The communication device as set forth in claim 1, wherein:
in the case where the subject application starts communicating with a second correspondent different from a first correspondent which is a current correspondent of the subject application, said physical layer selecting means selects from said plurality of physical layers, a physical layer not in use by the subject application, as a physical layer for use in communicating with the second correspondent.

18. The communication device as set forth in claim 17, wherein:
in the case where the physical layer as selected for use in communicating with the second correspondent cannot be used, said physical layer selecting means selects the physical layer in use for communicating with the first correspondent to be used in common between the first correspondent and the second correspondent.

19. The communication device as set forth in claim 13, wherein:
in the case where the subject application starts communicating with a second correspondent different from a first correspondent to which the subject application is communicating, said physical layer selecting means selects between the first physical layer in use by the subject application and the second physical layer, the second physical layer to be used by both of said first correspondent and said second correspondent.

20. The communication device as set forth in claim 19, wherein:
in the case where the physical layer as selected for use in communicating with the second correspondent cannot be used, said physical layer selecting means selects the first physical layer to be used by both of the first correspondent and the second correspondent.

21. The communication device as set forth in claim 1, further comprising:
communication state presenting means which presents a communication state of each of said plurality of layers.

22. The communication device as set forth in claim 5, further comprising:
communication state presenting means which presents a communication state of each of said plurality of layers.

23. The communication device as set forth in claim 21, further comprising:
a plurality of subject applications, wherein
said communication state presenting means presents whether a communication state of each physical layer is capable of providing communications in the communication quality level required by each application.

24. The communication device as set forth in claim 21, wherein:
communication state presenting means presents not only the communication state of each of said plurality of physical layers but also the physical layer being selected by said physical layer selecting means.

25. The communication device as set forth in claim 21, wherein:
communication state presenting means presents said communication state in a display together with said subject application.

26. The communication device as set forth in claim 1, wherein:
said communication device is a video receiving device or a video storage device.

27. The communication device as set forth in claim 1, wherein:
said communication device is a video transmitting device.

28. A program which makes a computer operate as:
memory means for storing a communication quality level required by a subject application; and
physical layer selecting means for selecting among said plurality of physical layers, a physical layer currently capable of providing communications in the communication quality level required by the subject application, as a physical layer for the subject application to use in communicating.

29. A recording medium storing a program which makes a computer operate as:
memory means for storing a communication quality level required by an a subject application; and
physical layer selecting means for selecting among said plurality of physical layers, a physical layer currently capable of providing communications in the communication quality level required by the subject application, as a physical layer for the subject application to use in communicating.
